(19) United States
(12) Patent Application Publication
(10) Pub. No.: US 2015/0127837 A1
(43) Pub. Date: May 7, 2015

(54) RELAY APPARATUS AND DATA TRANSFER METHOD

(71) Applicant: HITACHI, LTD., Tokyo (JP)

(72) Inventors: Shingo HARASHIMA, Tokyo (JP); Kozo IKEGAMI, Tokyo (JP); Hiroaki MIYATA, Tokyo (JP)

(21) Appl. No.: 14/533,452

(22) Filed: Nov. 5, 2014

(30) Foreign Application Priority Data
Nov. 6, 2013 (JP) 2013-230067

(51) Int. Cl. H04L 29/08

(52) U.S. Cl. CPC H04L 67/14
USPC 709/227

(57) ABSTRACT

A relay apparatus for transferring data between a terminal on which an application runs and a server, the relay apparatus including, a TCP management module for monitoring a packet to be transmitted and received by using TCP connection established between the terminal and the server; a determination module for analyzing a request packet and determining whether or not to switch a communication route for transmitting the request packet; a request transmission module for establishing new TCP connection on a new communication route and transmitting the request packet to the server; and a data relay module for transferring a data storage packet to the terminal by using the new TCP connection.

### CLAIM OF PRIORITY

The present application claims priority from Japanese patent application JP 2013-230067 filed on Nov. 6, 2013, the content of which is hereby incorporated by reference into this application.

### BACKGROUND OF THE INVENTION

This invention relates to a packet relay apparatus and a data transfer method.

Currently, a telecommunications carrier provides Internet connection services for coupling a user terminal to the Internet via an access line such as Asymmetric Digital Subscriber Line (ADSL), Fiber to the Home (FTTH), or a wireless network. Contents of the Internet are provided by a contents provider, and broadband contents such as moving image distribution are increasing. Such traffic bears heavily on a band of a communication device of the telecommunications carrier.

The Internet services provided by the telecommunications carrier are best efforts. Thus, the traffic of the broadband contents may have an influence such as discarding or delaying of other user traffic. This requires the telecommunications carrier to make equipment investments to deal with a traffic increase. However, unlike a content business for gaining revenue from contents, the Internet services of the telecommunications carrier are provided mainly based on flat rate pricing or flat-rate and usage-based pricing where an upper limit amount is set. As a result, there is a limit to the equipment investments of the telecommunications carrier.

Thus, the telecommunications carrier may pursue a study on traffic offloading that does not affect other user traffic by specifying data such as a moving image to allocate the data to an offloading service route (communication route) rather than by simply reinforcing lines. The telecommunications carrier may pursue a study on a new charging method of collecting fees for each service network to be used by switching, based on a type of an application or data, service routes different in characteristics such as a normal route, a broadband route, and a low-delay route.

Hitherto, a port number, which is information on Layer 4, is used for specifying a type of an application or data. However, with the popularization of web programming, much communication including a moving image is transferred by Hyper Text Transfer Protocol (HTTP), resulting in the situation where port numbers may not be able to sufficiently specify types of applications or data. Thus, a technology for identifying, by using information in HTTP (Layer 7), a type of an application or data to switch a communication route is necessary.

As the technology for identifying the type of the application or the data based on the information in HTTP, there is known a technology using a proxy server. The proxy server is a relay apparatus that filters contents, hides an Internet Protocol (IP) address of a user terminal, and reduces loads on a web server and a communication line. The user terminal establishes Transmission Control Protocol (TCP) connection between the user terminal itself and the proxy server, and requests contents to the proxy server. The proxy server establishes TCP connection between the proxy server itself and the web server, and requests contents to the web server in place of the user terminal.

As a technology similar to that using the proxy server, there is known a technology using a transparent proxy server. In communication using the transparent proxy server, the user terminal transmits a packet addressed not to the transparent proxy server but to the web server. The transparent proxy server, which has a function similar to that of the proxy server, monitors HTTP communication (destination port number 80) from the user terminal to the web server. The transparent proxy server replaces, when a packet of the HTTP communication has been received, a transmission source IP address with an IP address of the transparent proxy server, and transmits the packet to the web server. The transparent proxy server replaces, when a packet has been received from the web server, a destination IP address with an IP address of the user terminal, and transmits the packet to the user terminal.

Through the above-mentioned operation, although no direct communication is executed between the user terminal and the web server, the user terminal establishes connection to the web server, and recognizes that the user terminal directly obtains contents from the web server.

Each of the proxy server and the transparent proxy server has the function of identifying the type of the application or the data by monitoring the communication based on HTTP but does not have a function of switching the service route.

As a technology for identifying the type of the application or the data based on the communication via HTTP to switch the service route, there is a technology described in International Patent W02011/037105A. International Patent W02011/037105A discloses that “in order to resolve this problem, data from a transmission source terminal is terminated at a relay device and the contents are transferred to a network controller. The network controller distributes the flow information necessary in relay while setting the flow transfer instructions for a switch. The distributed flow information is notified to the relay device, and the relay device sets the communication flow to a destination terminal using the specified flow information and relays data from the transmission source terminal to the destination terminal.”.

### SUMMARY OF THE INVENTION

In International Patent W02011/037105A, the user terminal establishes TCP connection not to the web server but to the relay apparatus, and requests contents to the relay apparatus by using the TCP connection. This requires a user to know an IP address of the relay apparatus in advance. It is necessary to change the user terminal so that the user terminal communicates to the relay apparatus to request contents to the relay apparatus.

A network in International Patent W02011/037105A is a network based not on autonomous distribution but on central control performed by a controller. This requires introduction of the controller of the network and a switch for communicating to the controller. The Internet connection services of the telecommunications carrier are provided with use of a large network such as an IP network. Thus, when the technology described in International Patent W02011/037105A is applied, great changes of apparatus are necessary.

As a method of directly requesting contents to the web server by the user terminal and switching the service route during communication, a switching method using a transparent proxy server that includes a plurality of network interfaces may be used. When the transparent proxy server includes the plurality of network interfaces to which different IP addresses are allocated, a destination IP address of a packet to be transmitted from the web server to the transparent proxy server can be changed by changing a transmission source IP address of the packet received from the user terminal to an IP address of the transparent proxy server. This enables switching of the communication route from the web server to the transparent proxy server. By changing the network interface to be used by the transparent proxy server for transmitting the packet to the web server, the service route from the transparent proxy server to the web server can be changed.

However, in the case of the above-mentioned method, because of the TCP connection established between the transparent proxy server and the web server, an IP address to be replaced needs to be selected at the time of establishing the TCP connection, and hence an IP address to be replaced cannot be changed after analysis of an HTTP request enabling identification of the type of the application or the data in HTTP. In other words, the service route cannot be switched based on the type of the application or the data in HTTP.

It is therefore an object of this invention to provide a relay apparatus capable of switching a service route based on an analysis result of an HTTP request without changing a configuration and setting of a user terminal, without any awareness of switching of the service route, and without greatly changing an IP network of a telecommunications carrier.

The present invention can be appreciated by the description which follows in conjunction with the following figures, wherein: a relay apparatus for transferring data between a terminal on which an application for carrying out communication by using TCP runs and a server for transmitting data requested by the application. The relay apparatus comprises a processor, a memory coupled to the processor, and a plurality of network interfaces coupled to the processor and configured to couple to other apparatus. The relay apparatus is configured to be coupled to the terminal via a first network, and be coupled to the server via a plurality of communication routes included in a second network. The relay apparatus includes, a TCP management module for monitoring a packet to be transmitted and received by using TCP connection established between the terminal and the server via the first network and one of the plurality of communication routes included in the second network; a determination module for analyzing a request packet in a case where the TCP management module detects reception of the request packet through which the application running on the terminal requests the server to transmit data, and for determining whether or not to switch a communication route of the second network for transmitting the request packet based on a result of the analysis; a request transmission module for establishing new TCP connection to be used by the relay apparatus and the server to carry out communication on a new communication route in a case where the determination module determines to switch to a new communication route of the second network, and for transmitting the request packet to the server by using the new TCP connection; and a data relay module for transferring a data storage packet including the data requested by the application to the terminal by using the new TCP connection.

According to one embodiment of this invention, the communication route can be switched based on the analysis result of the request without any awareness of presence of the relay apparatus or switching of the service route by the terminal and without greatly changing the network of the telecommunications carrier.

Other objects, configurations, and effects than the above become apparent from the following description of the embodiments.

### BRIEF DESCRIPTION OF THE DRAWINGS

The present invention can be appreciated by the description which follows in conjunction with the following figures, wherein:

FIG. 1 is an explanatory diagram illustrating a configuration example of a communication system according to an embodiment;

FIG. 2 is a block diagram illustrating a hardware configuration and a software configuration of a relay apparatus according to the embodiment;

FIG. 3 shows a configuration example of a connection management table according to the embodiment;

FIG. 4 shows a configuration example of a rule table according to the embodiment;

FIG. 5 shows a configuration example of a proxy response table according to the embodiment;

FIG. 6 is an explanatory diagram illustrating an example of a notification content of an ACK reception notification or a FIN reception notification according to the embodiment;

FIGS. 7A, 7B, and 7C are explanatory diagrams each illustrating an example of an HTTP message according to the embodiment;

FIG. 8 is a flowchart illustrating details on monitoring processing executed by a monitoring module according to the embodiment;

FIG. 9 is a flowchart illustrating user side proxy response processing executed by the monitoring module according to the embodiment;

FIG. 10 is a flowchart illustrating rule determination processing executed by a rule determination module according to the embodiment;

FIG. 11 is a flowchart illustrating HTTP request transmission processing executed by a HTTP request transmission module according to the embodiment;

FIG. 12 is a flowchart illustrating data relay processing executed by a data relay module according to the embodiment;

FIG. 13 is a flowchart illustrating response processing executed by a response module according to the embodiment;

FIGS. 14A and 14B are sequential diagrams each illustrating a flow of communication when a service route in the communication system according to the embodiment is not switched;

FIGS. 15A and 15B are sequential diagrams each illustrating a flow of communication when the service route in the communication system according to the embodiment is switched;

FIG. 16 is a sequential diagram illustrating a flow of communication when the service route in the communication system according to the embodiment is not switched; and

FIG. 17 is a sequential diagram illustrating a flow of communication when the service route in the communication system according to the embodiment is switched.

### DETAILED DESCRIPTION OF THE PREFERRED EMBODIMENTS

Now, embodiments of this invention are described in detail referring to the drawings.

### First Embodiment

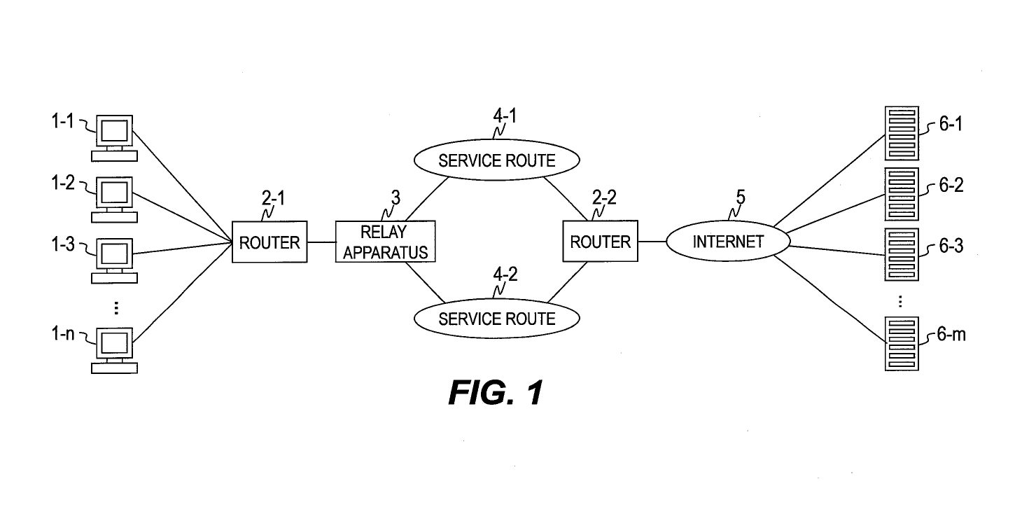

FIG. 1 is an explanatory diagram illustrating a configuration example of a communication system according to an embodiment of this invention.

The communication system according to this embodiment includes a plurality of user terminals 1, a plurality of routers 2, a relay apparatus 3, a plurality of service routes 4, the Internet 5, and a plurality of web servers 6.

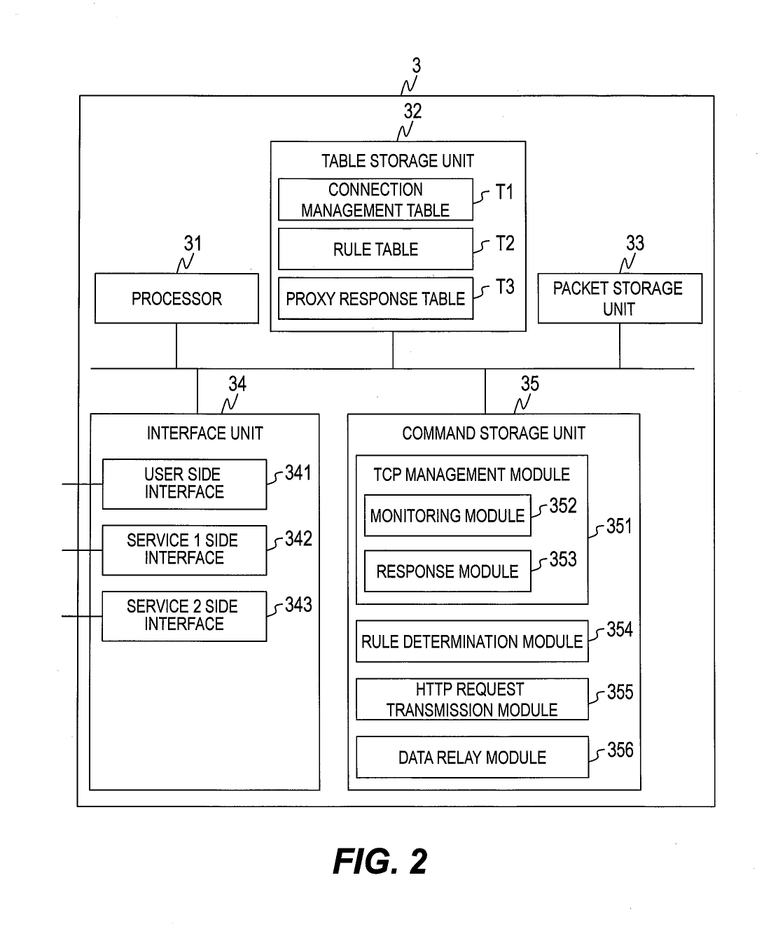

The relay apparatus 3 is an apparatus for carrying out packet relay processing, and is coupled to a router 2-1, a service route 4-1, and a service route 4-2. The relay apparatus 3 includes network interfaces respectively coupled to the service route 4-1 and the service route 4-2, and holds a rule table (T2) illustrated in FIG. 2 as described below. The rule table (T2) illustrated in FIG. 2 stores information for identifying an application or data based on communication via the Hyper Text Transfer Protocol (HTTP), and switching a service route from the service route 4-1 to the service route 4-2.

The service routes 4 are communication routes provided by telecommunications carriers. The service routes 4 may be provided by the same telecommunications carrier or different telecommunications carriers. In this embodiment, normal communication is carried out via the service route 4-1, and communication corresponding to a rule described below is carried out via the service route 4-2.

The rule for switching the service routes 4 may be set in advance by the telecommunications carrier, or inquired from a data server that holds a rule table. Alternatively, a user may set a rule for selecting the service route 4 to be used by the user terminal 1.

The user terminal 1 is coupled to the relay apparatus 3 via the router 2-1. The user terminal 1 includes hardware such as a processor (not shown), a memory (not shown), and an interface (not shown). An application (not shown) for carrying out communication by using TCP runs on the user terminal 1. In this embodiment, n user terminals 1-1 to 1-n are present. An IP address “10.0.0.n” is set to the user terminal 1-n in advance.

In this invention, the connection method between the user terminal 1 and the relay apparatus 3 is not limited. The user terminal 1 and the relay apparatus 3 may be coupled to each other by wire or by wireless. At least a part between the user terminal 1 and the relay apparatus 3 may be coupled by wireless.

The router 2-2 is set in advance to couple the plurality of service routes 4 to the Internet 5, and transfer a packet addressed to the user terminal 1 via the service route 4-1.

The web server 6 is a computer for distributing various contents in response to requests from the user terminals 1, and is coupled to the relay apparatus 3 via the Internet 5 and the router 2-2. The web server 6 includes hardware such as a processor (not shown), a memory (not shown), a storage device (not shown), and an interface (not shown). The web server 6 may be coupled to a storage system. In such a case, the web server 6 is not required to include any storage device (not shown). In this embodiment, m web servers 6-1 to 6-m are present, each of which has an individual domain. For example, in the web server 6-m, an IP address “10.0.1.m” and a domain “serverm.com” are set in advance. Contents distributed by the web server 6 include text information, an image, and a moving image.

Now, an overview of this invention is described.

In the communication system according to this embodiment, in a case where the user terminal 1 requests contents held in the web server 6 by using the HTTP, the user terminal 1 communicates to the web server 6 to establish TCP connection referred to as 3-way handshake.

The relay apparatus 3 monitors handshake communication to register connection information in a connection management table (T1) illustrated in FIG. 2 to be described below. While the TCP connection is alive, the relay apparatus 3 transfers a packet received from the user terminal 1 to the web server 6 via the service route 4-1, and transfers a packet received from the web server 6 to the user terminal 1. At this time, the relay apparatus 3 carries out only packet monitoring, and does not carry out any special processing such as an operation of the packet.

After the TCP connection has been established between the user terminal 1 and the web server 6, the user terminal 1 transmits a packet including an HTTP request to the web server 6. In the description below, the packet including the HTTP request is also referred to as an HTTP request packet. During the communication between the user terminal 1 and the web serve 6, an ACK number and a sequence number used at the time of establishing the TCP connection are continuously used.

In a case where the relay apparatus 3 receives the HTTP request packet, the relay apparatus 3 refers to the conditions stored in the rule table (T2) illustrated in FIG. 2 to determine which of the service route 4-1 and the service route 4-2 to use for carrying out communication.

In a case where the HTTP request does not satisfy the conditions, the relay apparatus 3 carries out communication via the service route 4-1. The relay apparatus 3 deletes connection information from the connection management table (T1), and transfers the HTTP request packet to the web server 6 via the service route 4-1. The connection management table (T1) does not include any connection information of a packet received after the transmission of the HTTP request packet. Accordingly, the relay apparatus 3 transfers a packet received from the web server 6 to the user terminal 1, and transfers a packet received from the user terminal 1 to the web server 6 via the service route 4-1.

On the other hand, in a case where the HTTP request satisfies the conditions, the relay apparatus 3 registers proxy response information in a proxy response table (T3) illustrated in FIG. 2 as a communication target via the service route 4-2. Then, the relay apparatus 3 generates, based on header information of the HTTP request packet, an RST packet addressed to the web server 6, and transmits the RST packet to the web server 6 via the service route 4-1. Thus, the TCP connection between the relay apparatus 3 and the web server 6 is disconnected. However, the relay apparatus 3 does not transmit the RST packet to the user terminal 1. Accordingly, the TCP connection between the user terminal 1 and the relay apparatus 3 is maintained.

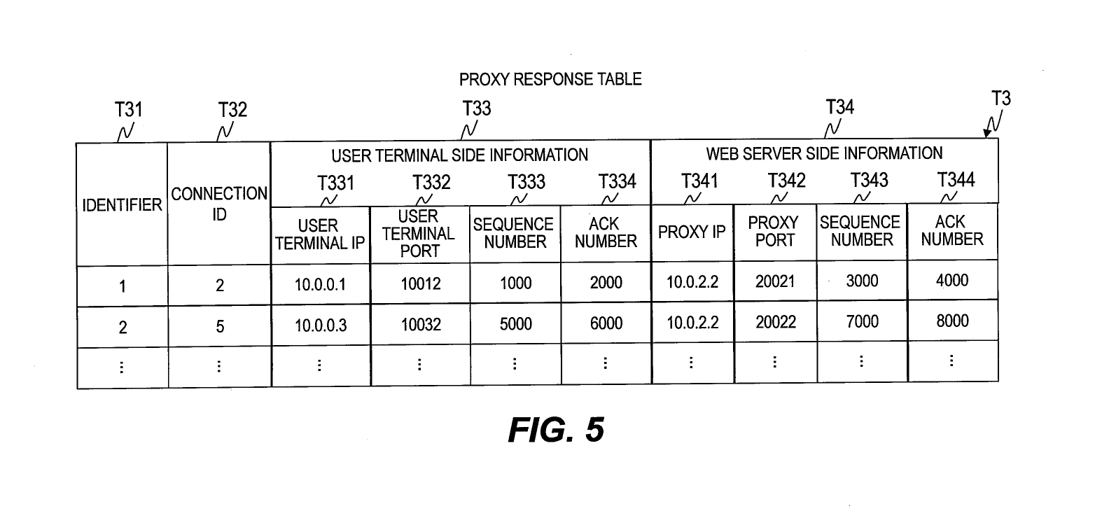

Then, the relay apparatus 3 establishes new TCP connection on the service route 4-2 for coupling the relay apparatus 3 to the web server 6. The relay apparatus 3 rewrites, based on web server side information (T34) of the proxy response information shown in FIG. 5, a transmission source IP address, a transmission source port number, a sequence number, and an ACK number of the HTTP request packet received from the user terminal 1, and transmits the HTTP request packet to the web server 6 via the service route 4-2. In a case where the relay apparatus 3 receives an ACK packet from the web server 6, the relay apparatus 3 rewrites, based on user terminal side information (T33) of the proxy response information shown in FIG. 5, a destination IP address, a destination port number, a sequence number, and an ACK number of the ACK packet, and transfers the ACK packet to the user terminal 1.

Then, until the delivery of the contents from the web server 6 is completed and the user terminal 1 therefore disconnects the TCP connection, the relay apparatus 3 controls the communication between the user terminal 1 and the web server 6 via the service route 4-2.

Specifically, in a case where the relay apparatus 3 receives a packet from the web server 6, the relay apparatus 3 rewrites, based on the user terminal side information (T33) of the proxy response information, a destination IP address, a destination port number, a sequence number, and an ACK number of the received packet, and transfers the packet to the user terminal 1. In a case where the relay apparatus 3 receives a packet from the user terminal 1, the relay apparatus 3 rewrites, based on the web server side information (T34) of the proxy response information, a transmission source IP address, a transmission source port number, a sequence number, and an ACK number of the received packet, and transfers the packet to the web server 6 via the service route 4-2.

After the user terminal 1 has disconnected the TCP connection, the relay apparatus 3 deletes the connection information from the connection management table (T1), and deletes the proxy response information from the proxy response table (T3).

In this embodiment, the communication carried out between the web server 6 and the relay apparatus 3 and the communication carried out between the relay apparatus 3 and the user terminal 1 are synchronized with each other, and the relay apparatus 3 transmits an ACK packet to the web server 6 after receiving the ACK packet from the user terminal 1. However, this invention is not limited to this arrangement. The relay apparatus 3 may transmit, without synchronization, the ACK packet to the web server 6 immediately after receiving a content from the web server 6. This allows the ACK packet to reach the web server 6 earlier, thus providing an effect of shortening content transfer time. In this case, the relay apparatus 3 may store the packet in a packet storage unit 33 until the relay apparatus 3 transmits the packet received from the web serve 6 to the user terminal 1.

In this embodiment, the relay apparatus 3 similarly establishes synchronization in the sequence at the time of disconnecting the TCP connection. However, this invention is not limited to this arrangement. The relay apparatus 3 may transmit, without synchronization, an ACK packet and a FIN packet to the web server 6 immediately after receiving a FIN packet from the web server 6, and transmit an ACK packet to the user terminal 1 immediately after receiving a FIN packet from the user terminal 1. This allows the ACK packet and the FIN packet to reach the web server 6 earlier and the ACK packet to reach the user terminal 1 earlier, thus providing an effect of shortening TCP connection duration, to thereby release resources for maintaining the TCP connection earlier.

FIG. 2 is a block diagram illustrating a hardware configuration and a software configuration of the relay apparatus 3 according to the embodiment of this invention.

The relay apparatus 3 includes a processor 31, a table storage unit 32, the packet storage unit 33, an interface unit 34, and a command storage unit 35.

The processor 31 reads a program stored in the command storage unit 35 to carry out the program, thereby being capable of achieving a function of the relay apparatus 3.

The table storage unit 32 stores various types of information to be used for processing. The table storage unit 32 can be implemented by using, for example, a memory such as a dynamic random access memory (DRAM). The table storage unit 32 according to this embodiment stores three tables, namely, the connection management table (T1), the rule table (T2), and the proxy response table (T3).

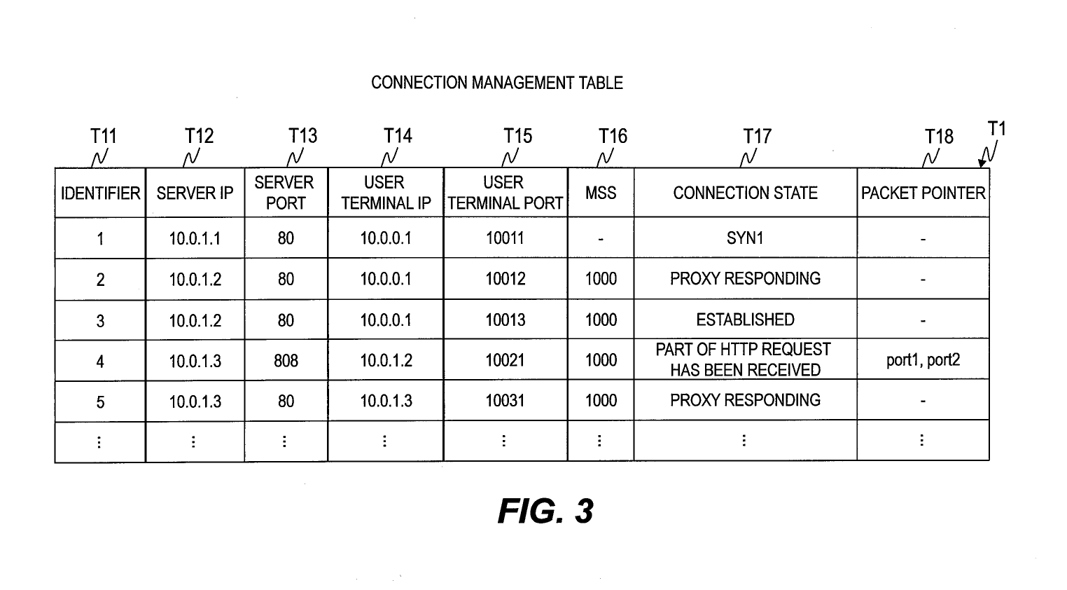

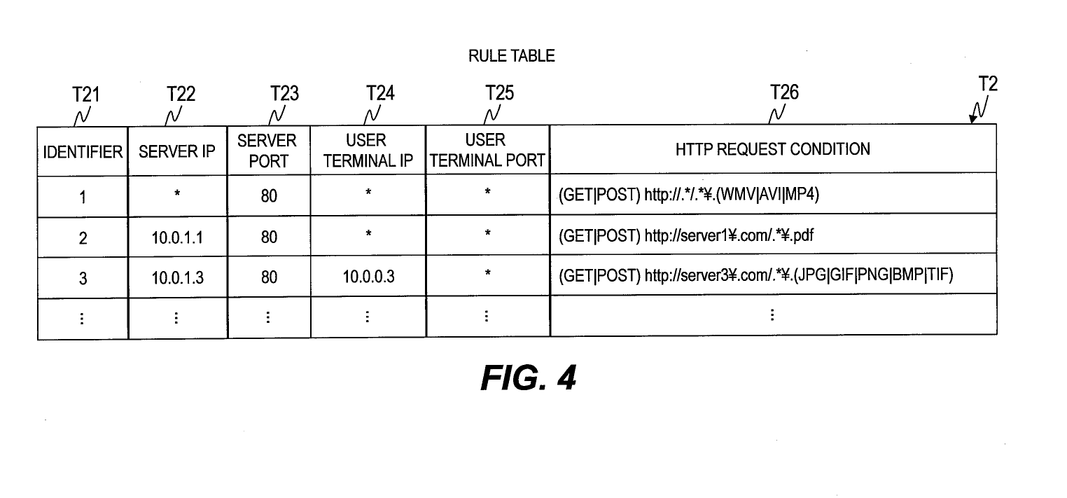

The connection management table (T1) stores information on a connection state between the user terminal 1 and the web server 6. Details on the connection management table (T1) are described below referring to FIG. 3. The rule table (T2) stores information for switching the service route from the service route 4-1 to the service route 4-2. Details on the rule table (T2) are described below referring to FIG. 4. The proxy response table (T3) stores information necessary for transferring a packet in a case where communication is carried out via the service route 4-2. Details on the proxy response table (T3) are described below referring to FIG. 5.

In this embodiment, the rule table (T2) is stored in advance in the table storage unit 32. However, this invention is not limited to this arrangement. For example, an external database may hold the rule table (T2), and the relay apparatus 3 may obtain the rule table (T2) from the external database.

In a case where an HTTP request is divided into a plurality of packets, the packet storage unit 33 stores a copy of HTTP request packets including the divided HTTP request. The packet storage unit 33 can be implemented by using, for example, a memory such as a DRAM.

The interface unit 34 includes a plurality of interfaces for connection to external apparatus or networks. The interface unit 34 according to this embodiment includes a user side interface 341, a service 1 side interface 342, and a service 2 side interface 343.

The user side interface 341 is an interface for connection to the router 2-1 to which the user terminal 1 is coupled. The service 1 side interface 342 is an interface for connection to the web server 6 via the service route 4-1. In this embodiment, an IP address “10.0.2.1” is set in the service 1 side interface 342. The service 2 side interface 343 is an interface for connection to the web server 6 via the service route 4-2. In this embodiment, an IP address “10.0.2.2” is set in the service 2 side interface 343.

The command storage unit 35 stores programs to be executed by the processor 31. The command storage unit 35 can be implemented by using a memory such as a DRAM. The command storage unit 35 according to this embodiment stores programs for implementing a TCP management module 351, a rule determination module 354, an HTTP request transmission module 355, and a data relay module 356. The command storage unit 35 also includes a control unit for controlling packet transmission and reception, which is not illustrated because such a control unit is known.

The TCP management module 351 manages monitoring of TCP connection and communication using HTTP on TCP such as a type of an application or data in HTTP via the TCP connection. The TCP management module 351 includes a plurality of program modules. Specifically, the TCP management module 351 includes a monitoring module 352 and a response module 353.

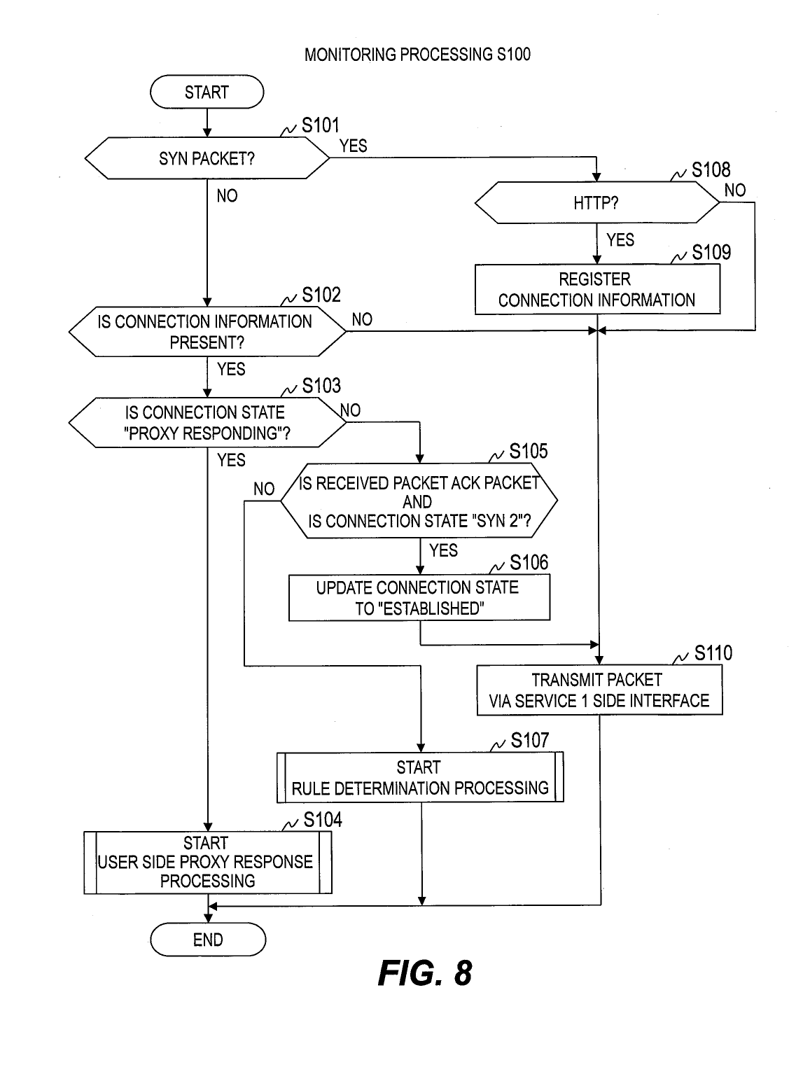

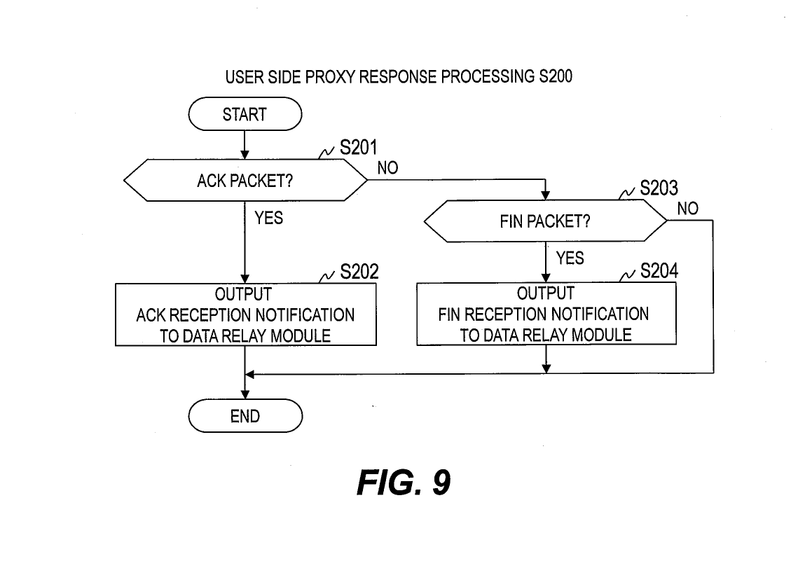

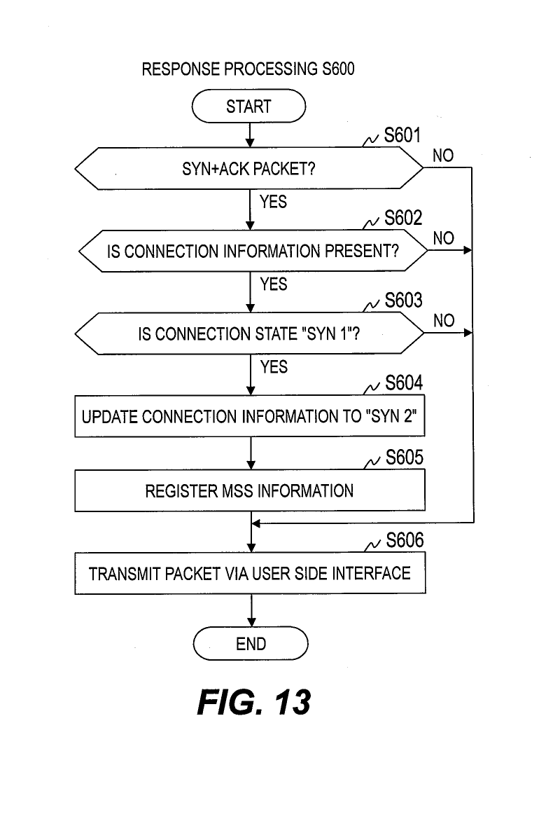

The monitoring module 352 carries out processing for a packet received from the user side interface 341. Details on the processing executed by the monitoring module 352 are described below referring to FIGS. 8 and 9. The response module 353 carries out processing for a packet received from the service 1 side interface 342. Details on the processing executed by the response module 353 are described below referring to FIG. 13.

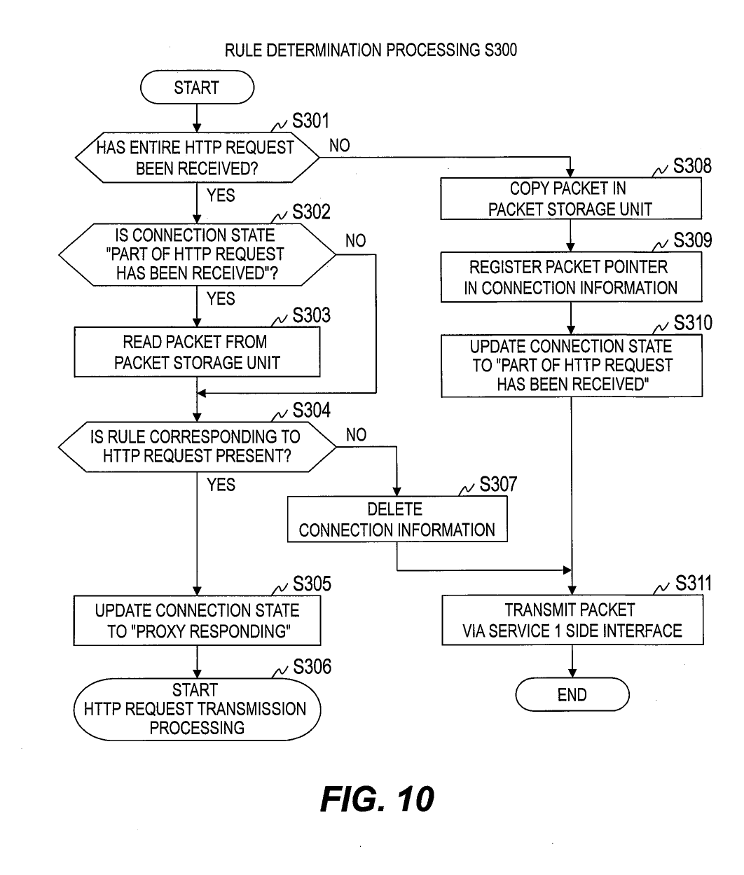

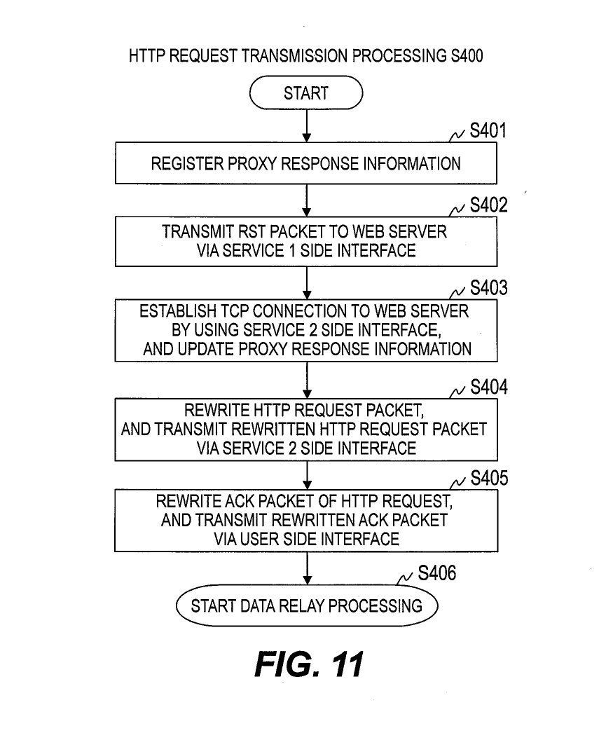

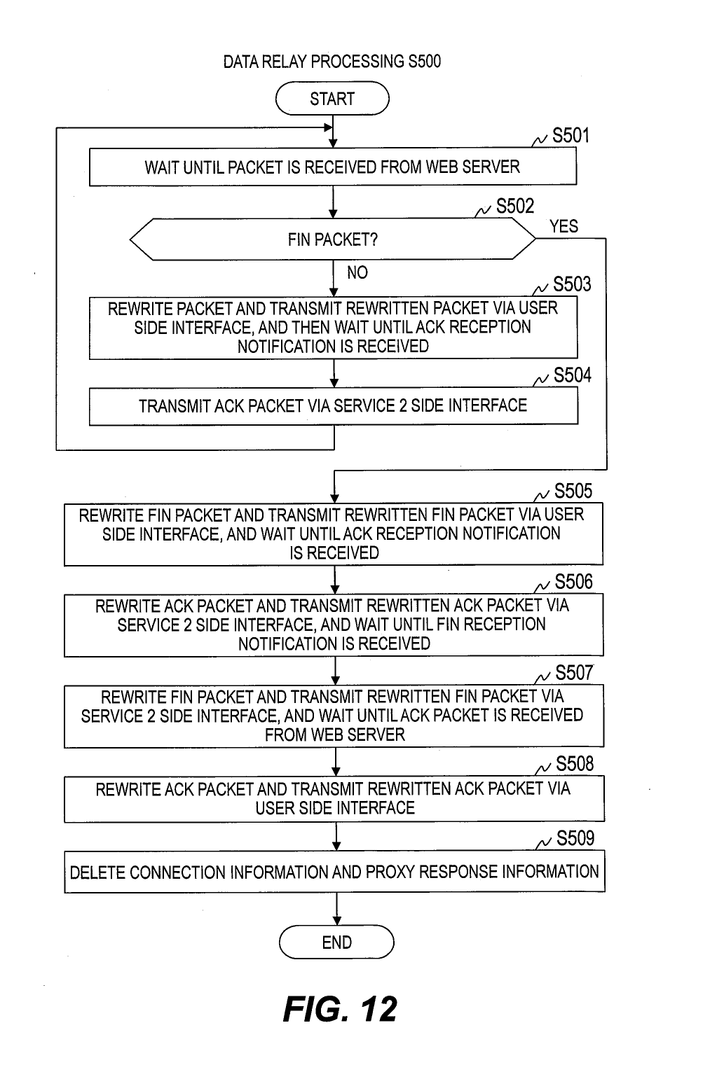

The rule determination module 354 determines whether or not to switch the service route from the service route 4-1 to the service route 4-2. Details on processing executed by the rule determination module 354 are described below referring to FIG. 10. In a case where the HTTP request transmission module 355 receives an HTTP request satisfying the rule, the HTTP request transmission module 355 establishes new TCP connection to carry out communication via the service route 4-2. Details on processing executed by the HTTP request transmission module 355 are described below referring to FIG. 11. During the communication via the service route 4-2, the data relay module 356 rewrites an IP address or the like of a packet transmitted and received between the user terminal 1 and the web server 6, and transfers the resultant packet. Details on processing executed by the data relay module 356 are described below referring to FIG. 12.

In the example illustrated in FIG. 2, the table storage unit 32 and the command storage unit 35 are described as separate components. However, this invention is not limited to this arrangement. For example, a region of one memory is divided into two regions, and one region may be set as the table storage unit 32 while the other region may be set as the command storage unit 35. The table storage unit 32, the packet storage unit 33, and the command storage unit 35 may also be implemented by using storage devices such as a hard disk drive (HDD) or a solid-state drive (SSD) other than the memory.

FIG. 3 shows a configuration example of the connection management table (T1) according to the embodiment of this invention.

The connection management table (T1) stores connection information indicating a state of the TCP connection established between the user terminal 1 and the web server 6. The connection information is generated when a SYN packet to be transmitted from the user terminal 1 to the web server 6 is received. The connection information includes an identifier (T11), a server IP (T12), a server port (T13), a user terminal IP (T14), a user terminal port (T15), an MSS (T16), a connection state (T17), and a packet pointer (T18).

The identifier (T11) is an identification number for identifying the connection information stored in the connection management table (T1). The server IP (T12) is an IP address allocated to the web server 6. The server port (T13) is a port number of the web server 6. The user terminal IP (T14) is an IP address allocated to the user terminal 1. The user port (T15) is a port number of the user terminal 1.

The server IP (T12), the server port (T13), the user terminal IP (T14), and the user terminal port (T15) are information to be used by an application for carrying out communication by using HTTP.

The MSS (T16) is a maximum segment size (MSS) of the TCP connection. In a case where the relay apparatus 3 receives a SYN+ACK packet to be transmitted from the web server 6 to the user terminal 1, the relay apparatus 3 obtains MSS information included in the packet, and stores the obtained MSS information in the MSS (T16).

The connection state (T17) indicates the state of the TCP connection established between the relay apparatus 3 and the web server 6. In this embodiment, any one of five pieces of information, namely, “SYN 1”, “SYN 2”, “ESTABLISHED”, “PART OF HTTP REQUEST HAS BEEN RECEIVED”, and “PROXY RESPONDING” is stored in the connection state (T17).

The state “SYN 1” indicates an initial state when TCP connection is established, and the state “SYN 2” indicates that a SYN+ACK packet has been received. The state “ESTABLISHED” indicates that TCP connection has been established. The state “PART OF HTTP REQUEST HAS BEEN RECEIVED” indicates that an HTTP request has been divided into a plurality of packets. The state “PROXY RESPONDING” indicates that a packet is currently transferred via the service route 4-2.

The packet pointer (T18) is a pointer indicating a storage area of copy data of the HTTP request packet stored in the packet storage unit 33. A pointer is stored as the packet pointer (T18) in a case where the connection state (T17) is “PART OF HTTP REQUEST HAS BEEN RECEIVED”.

FIG. 4 shows a configuration example of the rule table (T2) according to the embodiment of this invention.

The rule table (T2) stores a rule for determining the service route 4 to be used. The rule includes an identifier (T21), a server IP (T22), a server port (T23), a user terminal IP (T24), a user terminal port (T25), an HTTP request condition (T26).

The identifier (T21) is an identification number for identifying the rule registered in the rule table (T2). The server IP (T22) is an IP address allocated to the web server 6, and identical to the server IP (T12). The server port (T23) is a port number of the web server 6, and identical to the server port (T13). The user terminal IP (T24) is an IP address allocated to the user terminal 1, and identical to the user terminal IP (T14). The user port (T25) is a port number of the user terminal 1, and identical to the user port (T15).

The HTTP request condition (T26) stores conditions on HTTP corresponding to Layer 7. For example, a condition for a Uniform Resource Locator (URL) or a condition for a Cookie content or other fields may be set in the HTTP request condition (T26). As the condition for the URL, a host name, a directory name, and a file name may be set as conditions, and a type of a content may be specified by setting a condition for a file extension.

A descriptive syntax of the condition stored in the HTTP request condition (T26) may be Perl Compatible Regular Expressions (PCRE) or another descriptive syntax. The symbol “*” shown in FIG. 4 indicates a wild card, which is a symbol representing an arbitrary character or a character string.

In the case of application to a communication protocol other than HTTP, information on the application layer in the Open Systems Interconnection (OSI) reference model may be set as a condition.

FIG. 5 shows a configuration example of the proxy response table (T3) according to the embodiment of this invention.

The proxy response table (T3) stores proxy response information necessary for transferring the packet received from the web server 6 or the user terminal 1 during the communication via the service 4-2. The proxy response information includes an identifier (T31), a connection ID (T32), user terminal side information (T33), and web server side information (T34).

The identifier (T31) is an identification number for identifying the proxy response information registered in the proxy response table (T3). The connection ID (T32) is an identification number of connection information, and corresponds to the identifier (T11). The connection ID (T32) is used as a search key for searching for proxy response information corresponding to the connection information.

The user terminal side information (T33) is information to be used when the packet received from the web server 6 is transferred to the user terminal 1. The user terminal side information (T33) includes a user terminal IP (T331), a user terminal port (T332), a sequence number (T333), and an ACK number (T334).

The user terminal IP (T331) is an IP address allocated to the user terminal 1, and identical to the user terminal IP (T14). The user terminal port (T332) is a port number of the user terminal 1, and identical to the user terminal port (T15). The sequence number (T333) and the ACK number (T334) are numbers to be used during transmission of the packet from the relay apparatus 3 to the user terminal 1.

The web server side information (T34) is information to be used when the packet received from the user terminal 1 is transferred to the web server 6. The web server side information (T34) includes a proxy IP (T341), a proxy port (T342), a sequence number (T343), and an ACK number (T344).

The proxy IP (T341) is an IP address of the relay apparatus 3. The proxy port (T342) is a port number of the relay apparatus 3. The sequence number (T343) and the ACK number (T344) are numbers to be used during transmission of the packet from the relay apparatus 3 to the web server 6.

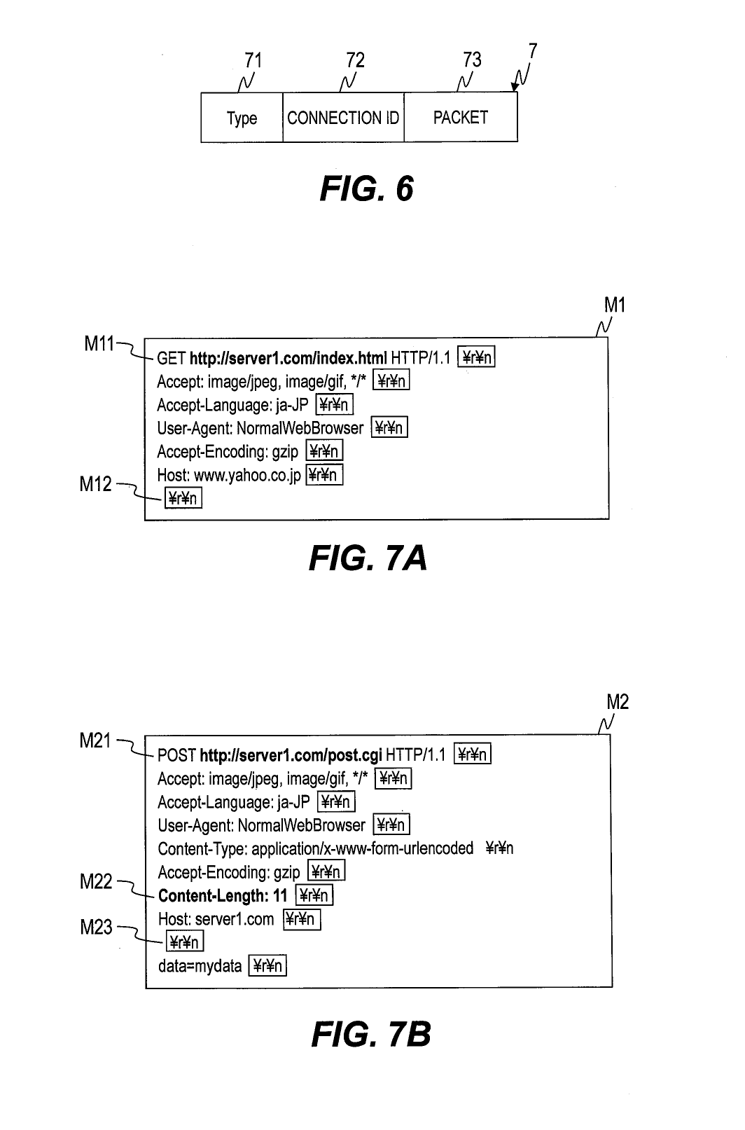

FIG. 6 is an explanatory diagram illustrating an example of a notification content of an ACK reception notification or a FIN reception notification according to the embodiment of this invention.

A notification content 7 includes a type 71, a connection ID 72, and a packet 73. The type 71 indicates one of the ACK reception notification and the FIN reception notification. The connection ID 72 is a connection identifier. The packet 73 stores an ACK packet or a FIN packet.

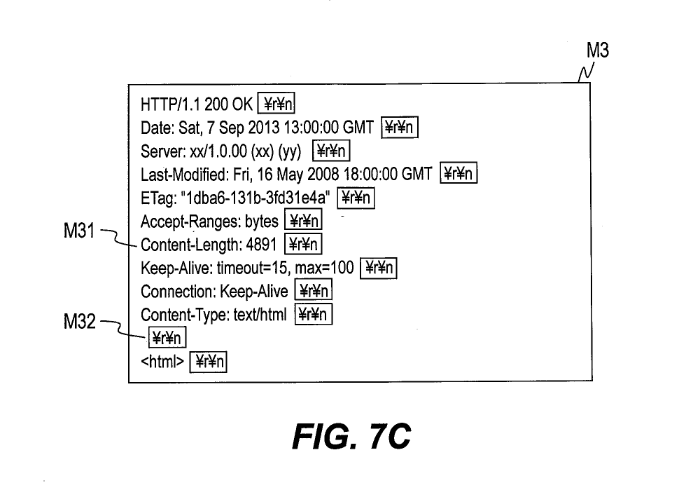

FIGS. 7A, 7B, and 7C are explanatory diagrams each illustrating an example of an HTTP message according to the embodiment of this invention.

FIG. 7A illustrates an example of an HTTP request (M1) using a GET method. FIG. 7B illustrates an example of an HTTP request (M2) using a POST method. FIG. 7C illustrates an example of an HTTP response (M3).

The HTTP message includes an HTTP method including a URL (M11) or (M12) to contents requested by the user terminal 1, a plurality of header fields, a blank row (M12), (M23), or (M32) indicating a tail end of the HTTP header, and an HTTP message body following the blank row.

One of the header fields, namely, Content-Length (M22) or (M31), is a field indicating a length of the HTTP message body.

Next, processing executed by the relay apparatus 3 is described referring to a flowchart.

FIG. 8 is a flowchart illustrating details on monitoring processing S100 executed by the monitoring module 352 according to the embodiment of this invention.

In a case where the TCP management module 351 receives a packet via the user side interface 341, the TCP management module 351 calls the monitoring module 352 to instruct execution of the processing.

In Step S101, the monitoring module 352 determines whether or not the received packet is a SYN packet.

In a case where it is determined that the received packet is not a SYN packet (NO in Step S101), in Step S102, the monitoring module 352 determines whether or not connection information relating to the packet is present in the connection management table (T1). Specifically, the following processing is executed. The monitoring module 352 obtains a transmission source IP address, a transmission source port number, a destination IP address, and a destination port number from the received packet. The monitoring module 352 searches for an entry where the server IP (T12), the server port (T13), the user terminal IP (T14), and the user terminal port (T15) match with the transmission source IP address, the transmission source port number, the destination IP address, and the destination port number that have been obtained.

In a case where the monitoring module 352 determines that no connection information relating to the received packet is present in the connection management table (T1) (NO in Step S102), the monitoring module 352 proceeds to Step S110. In a case where it is determined that connection information relating to the received packet is present in the connection management table (T1) (YES in Step S102), in Step S103, the monitoring module 352 refers to the connection information to determine whether or not the connection state (T17) is “PROXY RESPONDING”.

In a case where it is determined that the connection state (T17) is “PROXY RESPONDING” (YES in Step S103), in Step S104, the monitoring module 352 carries out user side proxy response processing S200, and ends the current processing. Details on the user side proxy response processing S200 are described below referring to FIG. 9.

In a case where it is determined that the connection state (T17) is not “PROXY RESPONDING” (NO in Step S103), in Step S105, the monitoring module 352 determines whether or not the received packet is an ACK packet and the connection state (T17) is “SYN 2”. In a case where the condition in Step S105 is satisfied, the received packet corresponds to an ACK packet received after reception of a SYN packet and a SYN+ACK packet of HTTP. In a case where the condition in Step S105 is not satisfied, the received packet corresponds to an HTTP request packet.

In a case where it is determined that the determination condition in Step S105 is not satisfied (NO in Step S105), in Step S107, the monitoring module 352 carries out rule determination processing S300, and ends the current processing. Details on the rule determination processing S300 are described below referring to FIG. 10.

In a case where it is determined that the determination condition in Step S105 is satisfied (YES in Step S105), in Step S106, the monitoring module 352 updates the connection state (T17) to “ESTABLISHED”, and then proceeds to Step S110.

In a case where it is determined that the received packet is a SYN packet (YES in Step S101), in Step S108, the monitoring module 352 determines whether or not the SYN packet is a packet to be transmitted via HTTP. Specifically, the monitoring module 352 obtains a destination port number included in the received packet, and determines whether or not the destination port number is a port number to be used for HTTP. The port number to be used for HTTP may be 80, 8080, 8000, or the like.

In a case where the monitoring module 352 determines that the received SYN packet is not a packet to be transmitted via HTTP (NO in Step S108), the monitoring module 352 proceeds to Step S110. In a case where it is determined that the received SYN packet is a packet to be transmitted via HTTP (YES in Step S108), in Step S109, the monitoring module 352 registers connection information in the connection management table (T1) by using information included in the SYN packet. Specifically, the following processing is executed.

The monitoring module 352 adds a row to the connection management table (T1), and sets a predetermined identification number as the identifier (T11) of the row. In this case, an identification number obtained by adding “1” to the identifier (T11) of the previous row is set as the identifier (T11). The monitoring module 352 obtains a transmission source IP address, a transmission source port number, a destination IP address, and a destination port number from the received SYN packet.

The monitoring module 352 sets the destination IP address as the server IP (T12), the destination port number as the server port (T13), the transmission source IP address as the user terminal IP (T14), and the transmission source port number as the user terminal port (T15). The monitoring module 352 further sets “SYN 1” as the connection state (T17). The processing of Step S109 has been described.

After the NO determination in Step S102, the execution of the processing of Step S106, the NO determination in Step S108, or the execution of the processing of Step S109, in Step S110, the monitoring module 352 transmits the received packet to the web server 6 via the service 1 side interface 342, and ends the processing.

FIG. 9 is a flowchart illustrating the user side proxy response processing S200 executed by the monitoring module 352 according to the embodiment of this invention.

In Step S201, the monitoring module 352 determines whether or not the received packet is an ACK packet.

In a case where it is determined that the received packet is an ACK packet (YES in Step S201), in Step S202, the monitoring module 352 outputs an ACK reception notification to the data relay module 356, and ends the processing.

In a case where it is determined that the received packet is not an ACK packet (NO in Step S201), in Step S203, the monitoring module 352 determines whether or not the received packet is a FIN packet.

In a case where it is determined that the received packet is not a FIN packet (NO in Step S203), the monitoring module 352 ends the processing.

In a case where it is determined that the received packet is a FIN packet (YES in Step S203), in Step S204, the monitoring module 352 outputs a FIN reception notification to the data relay module 356, and ends the processing.

As a method of outputting the ACK reception notification or the FIN reception notification, the monitoring module 352 may write the ACK reception notification or the FIN reception notification in a predetermined register in advance. In this case, the data relay module 356 can receive the ACK reception notification or the FIN reception notification by polling the register. This can also be achieved by the monitoring module 352 notifying the data relay module 356 of interruption.

FIG. 10 is a flowchart illustrating the rule determination processing S300 executed by the rule determination module 354 according to the embodiment of this invention.

The rule determination module 354 starts the rule determination processing S300 in response to an instruction to carry out processing from the monitoring module 352.

In Step S301, the rule determination module 354 determines whether or not an entire HTTP request has been received. For example, in the case of the HTTP request (M1) using the GET method, the rule determination module 354 determines that the entire HTTP request has been received when the rule determination module 354 receives a packet including the blank row (M12). In the case of the HTTP request (M2) using the POST method, the rule determination module 354 determines that the entire HTTP request has been received when the rule determination module 354 receives a packet of bytes indicated by Content-Length (M22) from the blank row (M23).

In a case where it is determined that the entire HTTP request has been received (YES in Step S301), in Step S302, the rule determination module 354 refers to the connection management table (T1) to determine whether or not the connection state (T17) of connection information corresponding to the HTTP request packet is “PART OF HTTP REQUEST HAS BEEN RECEIVED”.

In a case where it is determined that the connection state (T17) is not “PART OF HTTP REQUEST HAS BEEN RECEIVED” (NO in Step S302), the rule determination module 354 proceeds to Step S304. In a case where it is determined that the connection state (T17) is “PART OF HTTP REQUEST HAS BEEN RECEIVED” (YES in Step S302), in Step S303, the rule determination module 354 reads a packet from the packet storage unit 33. Specifically, the rule determination module 354 reads the packet from the packet storage unit 33 based on the packet pointer (T18) of the connection information.

In Step S304, the rule determination module 354 refers to the rule table (T2) based on the HTTP request packet to determine whether or not any rule corresponding to the HTTP request is present. For example, the following processing is executed.

The rule determination module 354 obtains a transmission source IP address, a transmission source port number, a destination IP address, and a destination port number from the HTTP request packet. The rule determination module 354 searches for a rule by comparing the transmission source IP address, the transmission source port number, the destination IP address, and the destination port number that have been obtained with the user terminal IP (T24), the user terminal port (T25), the server IP (T22), and the server port (T23). Moreover, the rule determination module 354 refers to the HTTP request condition (T26) of the retrieved rule to determine whether or not the HTTP request satisfies the condition. The example of the processing of Step S304 has been described.

In a case where it is determined that a rule corresponding to the HTTP request is present (YES in Step S304), in Step S305, the rule determination module 354 updates the connection state (T17) of the connection information to “PROXY RESPONDING”. In Step S306, the rule determination module 354 instructs the HTTP request transmission module 355 to carry out HTTP request transmission processing S400. Details on the HTTP request transmission processing S400 are described below in detail referring to FIG. 11.

In a case where it is determined that no rule corresponding to the HTTP request is present (NO in Step S304), in Step S307, the rule determination module 354 deletes the connection information from the connection management table (T1), and then the rule determination module 354 proceeds to Step S311.

In a case where it is determined that the entire HTTP request has not been received (NO in Step S301), in Step S308, the rule determination module 354 copies the received HTTP request packet in the packet storage unit 33. In Step S309, the rule determination module 354 registers, as the packet pointer (T18) of the connection information, a pointer indicating a storage area of the HTTP request packet stored in the packet storage unit 33.

In Step S310, the rule determination module 354 updates the connection state (T17) of the connection information to “PART OF HTTP REQUEST HAS BEEN RECEIVED”, and then the rule determination module 354 proceeds to Step S311.

After the execution of the processing of Step S307 or the execution of the processing of Step S310, in Step S311, the rule determination module 354 transmits the received HTTP request packet to the web server 6 via the service 1 side interface 342, and then ends the processing.

FIG. 11 is a flowchart illustrating the HTTP request transmission processing S400 executed by the HTTP request transmission module 355 according to the embodiment of this invention.

The HTTP request transmission module 355 starts the HTTP request transmission processing S400 in response to an instruction to carry out the processing from the rule determination module 354.

In Step S401, the HTTP request transmission module 355 registers proxy response information corresponding to the received HTTP request packet in the proxy response table (T3). Specifically, the following processing is executed.

The HTTP request transmission module 355 adds a row to the proxy response table (T3). The HTTP request transmission module 355 obtains the identifier (T11) of the connection information retrieved in Step S102, and obtains an IP address, a port number, a sequence number, and an ACK number of the user terminal 1 from the HTTP request packet.

The HTTP request transmission module 355 sets a predetermined identification number as the identifier (T31) of the added row, and sets an identification number obtained from the identifier (T11) of the connection information as the connection ID (T32). The HTTP request transmission module 355 further sets an IP address and a port number of the user terminal 1 as the user terminal IP (T331) and the user terminal port (T332) of the user terminal information (T33) of the added row.

The HTTP request transmission module 355 sets the obtained sequence number as the sequence number (T333) of the user terminal side information (T33) of the added row. Moreover, the HTTP request transmission module 355 sets the obtained ACK number as the ACK number (T334) of the user terminal side information (T33) of the added row. The processing of Step S401 has been described.

In Step S402, the HTTP request transmission module 355 generates an RST packet addressed to the web server 6 based on header information of the HTTP request packet, and transmits the RST packet to the web server 6 via the service 1 side interface 342. This operation is executed for the purpose of disconnecting the TCP connection on the service route 4-1.

In Step S403, the HTTP request transmission module 355 establishes new TCP connection on the service route 4-2 by using the service 2 side interface 343, and updates the proxy response information based on information on the established TCP connection. Specifically, the following processing is executed.

The HTTP request transmission module 355 performs 3-way handshake communication to the web server 6 by using the service 2 side interface 343. Accordingly, new TCP connection is established on the service route 4-2 for coupling the relay apparatus 3 to the web server 6. During the communication between the relay apparatus 3 and the web server 6, an ACK number and a sequence number used at the time of establishing the new TCP connection are continuously used.

The HTTP request transmission module 355 sets an IP address and a port number of the relay apparatus 3 as the proxy IP (T341) and the proxy port (T342) of the web server side information (T34) of the row added in Step S401. The HTTP request transmission module 355 further sets a sequence number and an ACK number, which are used when the relay apparatus 3 transmits a packet to the web server 6, as the sequence number (T343) and the ACK number (T344) of the web server side information (T34) of the added row, respectively. The processing of Step S403 has been described.

In Step S404, the HTTP request transmission module 355 rewrites a header of the HTTP request packet based on the web server side information (T34) of the proxy response information, and transmits the rewritten HTTP request packet to the web server 6 via the service 2 side interface 343. Specifically, the following processing is executed.

The HTTP request transmission module 355 rewrites the transmission source IP address and the transmission source port number of the HTTP request into the proxy IP (T341) and the proxy port (T342) of the web server side information (T34) of the proxy response information.

The HTTP request transmission module 355 determines, based on the sequence number (T343) and the ACK number (T344) of the web server side information (T34) of the proxy response information, a sequence number and an ACK number to be used for transmitting a packet to the web server 6. The HTTP request transmission module 355 rewrites the sequence number and the ACK number of the HTTP request into the determined sequence number and the determined ACK number. The processing of Step S404 has been described.

A method of determining the sequence number and the ACK number is known, and thus detailed description thereof is omitted.

After transmission of the rewritten HTTP request packet, the HTTP request transmission module 355 waits until an ACK packet is received in response to the HTTP request packet.

In a case where the HTTP request transmission module 355 receives an ACK packet addressed to the relay apparatus 3 from the web server 6, in Step S405, the HTTP request transmission module 355 rewrites a header of the ACK packet based on the user terminal side information (T33) of the proxy response information, and transmits the rewritten ACK packet to the user terminal 1 via the user side interface 341. Specifically, the following processing is executed.

The HTTP request transmission module 355 refers to the proxy response table (T3) to search for proxy response information having the proxy IP (T341) and the proxy port (T342) matching with a destination IP address and a destination port number of the ACK packet.

The HTTP request transmission module 355 sets the sequence number (T343) and the ACK number (T344) of the web server side information (T34) of the retrieved proxy response information as the sequence number and the ACK number of the ACK packet, and rewrites the destination IP address and the destination port number of the ACK packet into the user terminal IP (T331) and the user terminal port (T332) of the user terminal side information (T33) of the retrieved proxy response information.

The HTTP request transmission module 355 determines, based on the sequence number (T333) and the ACK number (T334) of the user terminal side information (T33) of the retrieved proxy response information, a sequence number and an ACK number to be used for transmitting a packet to the user terminal 1. The HTTP request transmission module 355 rewrites the sequence number and the ACK number of the ACK packet into the determined sequence number and the determined ACK number. The processing of Step S405 has been described.

In a case where the HTTP request transmission module 355 transmits the rewritten ACK packet, in Step S406, the HTTP request transmission module 355 instructs the data relay module 356 to carry out processing.

The HTTP request transmission module 355 may calculate in advance, based on the sequence number and the ACK number of the packet received from the user terminal 1, a sequence number and an ACK number to be used when a packet is transmitted to the user terminal 1, and store the calculated sequence number and the calculated ACK number as the sequence number (T333) and the ACK number (T334). In this case, the HTTP request transmission module 355 rewrites the sequence number and the ACK number of the ACK packet into the sequence number (T333) and the ACK number (T334). Similar control may be executed for the sequence number (T343) and the ACK number (T344) of the web server side information (T34).

FIG. 12 is a flowchart illustrating data relay processing 5500 executed by the data relay module 356 according to the embodiment of this invention.

The data relay module 356 starts the data relay processing S500 in response to an instruction to carry out the processing from the HTTP request transmission module 355.

In Step S501, after the start of the processing, the data relay module 356 waits until a packet addressed to the relay apparatus 3 is received from the web server 6. In Step S502, in a case where the data relay module 356 receives the packet from the web server 6, the data relay module 356 determines whether or not the packet is a FIN packet.

In a case where it is determined that the received packet is not a FIN packet, in other words, the received packet is a packet including a content (NO in Step S502), in Step S503, the data relay module 356 rewrites a header of the packet based on proxy response information corresponding to the packet, and transmits the rewritten packet to the user terminal 1 via the user side interface 341. Then, the data relay module 356 waits until an ACK reception notification is received. Specifically, the following processing is executed.

The data relay module 356 refers to the proxy response table (T3) to search for proxy response information having the proxy IP (T341) and the proxy port (T342) matching with a destination IP address and a destination port number of the received packet. The data relay module 356 sets the sequence number (T343) and the ACK number (T344) of the web server side information (T34) of the retrieved proxy response information as the sequence number and the ACK number of the packet, and rewrites the destination IP address and the destination port number of the ACK packet into the user terminal IP (T331) and the user terminal port (T332) of the user terminal side information (T33) of the retrieved proxy response information.

The data relay module 356 determines, based on the sequence number (T333) and the ACK number (T334) of the user terminal side information (T33) of the retrieved proxy response information, a sequence number and an ACK number to be used for transmitting a packet to the user terminal 1. The data relay module 356 rewrites the sequence number and the ACK number of the ACK packet into the determined sequence number and the determined ACK number. The processing of Step S503 has been described.

In a case where the data relay module 356 receives the ACK reception notification from the monitoring module 352, in Step S504, the data relay module 356 rewrites a header of the ACK packet based on proxy response information corresponding to an ACK packet included in the ACK reception notification, and transmits the rewritten ACK packet to the web server 6 via the service 2 side interface 343. Then, the data relay module 356 returns to Step S501. Specifically, the following processing is executed.

The data relay module 356 refers to the proxy response table (T3) to search for proXy response information having the connection ID (T32) matching with the connection ID 72 included in the ACK reception notification.

The data relay module 356 sets the sequence number (T333) and the ACK number (T334) of the user terminal side information (T33) of the retrieved proxy response information as the sequence number and the ACK number of the ACK packet, and rewrites the transmission source IP address and the transmission source port number of the ACK packet into the proxy IP (T341) and the proxy port (T342) of the web server side information (T34) of the retrieved proxy response information.

The data relay module 356 determines, based on the sequence number (T343) and the ACK number (T344) of the web server side information (T34) of the retrieved proxy response information, a sequence number and an ACK number to be used for transmitting a packet to the web server 6. The data relay module 356 rewrites the sequence number and the ACK number of the ACK packet into the determined sequence number and the determined ACK number. The processing of Step S504 has been described.

In a case where it is determined that the received packet is a FIN packet (YES in Step S502), in Step S505, the data relay module 356 rewrites a header of the FIN packet based on proxy response information corresponding to the FIN packet, and transmits the rewritten FIN packet to the user terminal 1 via the user side interface 341. Then, the data relay module 356 waits until an ACK reception notification is received from the monitoring module 352.

Specifically, the data relay module 356 carries out processing similar to that of Step S503 to search for proxy response information corresponding to the FIN packet in the proxy response table (T3). The data relay module 356 sets the sequence number (T343) and the ACK number (T344) of the web server side information (T34) of the retrieved proxy response information as the sequence number and the ACK number of the FIN packet, and rewrites a destination IP address, a destination port number, a sequence number, and an ACK number of the FIN packet based on the user terminal side information (T33).

In a case where the data relay module 356 receives the ACK reception notification from the monitoring module 352, in Step S506, the data relay module 356 rewrites a header of the ACK packet based on proxy response information corresponding to an ACK packet included in the ACK reception notification, and transmits the rewritten ACK packet to the web server 6 via the service 2 side interface 343. Then, the data relay module 356 waits until a FIN reception notification is received from the monitoring module 352.

Specifically, the data relay module 356 carries out processing similar to that of Step S504 to search for proxy response information corresponding to the ACK packet in the proxy response table (T3). The data relay module 356 sets the sequence number (T333) and the ACK number (T334) of the user terminal side information (T33) of the retrieved proxy response information as the sequence number and the ACK number of the ACK packet, and rewrites a destination IP address, a destination port number, a sequence number, and an ACK number of the ACK packet based on the web server side information (T34).

In a case where the data relay module 356 receives the FIN reception notification from the monitoring module 352, in Step S507, the data relay module 356 rewrites a header of the FIN packet based on proxy response information corresponding to a FIN packet included in the FIN reception notification, and transmits the rewritten FIN packet to the web server 6 via the service 2 side interface 343. Then, the data relay module 356 waits until an ACK packet addressed to the relay apparatus 3 is received from the web server 6.

Specifically, the data relay module 356 carries out processing similar to that of Step S504 to search for proxy response information corresponding to the FIN packet in the proxy response table (T3). The data relay module 356 sets the sequence number (T333) and the ACK number (T334) of the user terminal side information (T33) of the retrieved proxy response information as the sequence number and the ACK number of the FIN packet, and rewrites a destination IP address, a destination port number, a sequence number, and an ACK number of the ACK packet based on the web server side information (T34).

In a case where the data relay module 356 receives the ACK packet addressed to the relay apparatus 3 from the web server 6, in Step S508, the data relay module 356 rewrites a header of the ACK packet based on the user terminal side information (T33) of the proxy response information corresponding to the ACK packet, and transmits the rewritten ACK packet to the user terminal 1 via the user side interface 341.

Specifically, the data relay module 356 carries out processing similar to that of Step S503 to search for proxy response information corresponding to the ACK packet in the proxy response table (T3). The data relay module 356 sets the sequence number (T343) and the ACK number (T344) of the web server side information (T34) of the retrieved proxy response information as the sequence number and the ACK number of the ACK packet, and rewrites a destination IP address, a destination port number, a sequence number, and an ACK number of the ACK packet based on the user terminal side information (T33).

In Step S509, the data relay module 356 deletes the connection information and the proxy response information corresponding to the disconnected TCP connection from the connection management table (T1) and the proxy response table (T3), and ends the processing.

FIG. 13 is a flowchart illustrating response processing S600 executed by the response module 353 according to the embodiment of this invention.

In a case where the TCP management module 351 receives a packet via the service 1 side interface 342, the TCP management module 351 calls the response module 353 to instruct execution of the processing.

In Step S601, the response module 353 determines whether or not the received packet is a SYN+ACK packet of HTTP. In other words, the response module 353 determines whether or not the received packet is a SYN+ACK packet received after reception of a SYN packet.

In a case where it is determined that the received packet is not a SYN+ACK packet of HTTP (NO in Step S601), the response module 353 proceeds to Step S606. In a case where it is determined that the received packet is a SYN+ACK packet of HTTP (YES in Step S601), in Step S602, the response module 353 determines whether or not connection information relating to the received SYN+ACK packet is present in the connection management table (T1). As a determination method of Step S602, the same determination method as that of Step S102 may be used.

In a case where it is determined that no connection information is present (NO in Step S602), this is a case where illegal communication or a failure has occurred. However, the relay apparatus 3 transmits the packet to the user terminal 1 without particularly carrying out any processing for the packet. In this case, the user terminal 1 determines the occurrence of the illegal communication or the failure.

In a case where it is determined that no connection information relating to the received SYN+ACK packet is present in the connection management table (T1) (NO in Step S602), the response module 353 proceeds to Step S606. In a case where it is determined that connection information relating to the received SYN+ACK packet is present in the connection management table (T1) (YES in Step S602), in Step S603, the response module 353 determines whether or not the connection state (T17) of the connection information is “SYN 1”.

In a case where it is determined that the connection state (T17) of the connection information is not “SYN 1” (NO in Step S603), the response module 353 proceeds to Step S606. In a case where it is determined that the connection state (T17) of the connection information is “SYN 1” (YES in Step S603), in Step S604, the response module 353 updates the connection state (T17) to “SYN 2”.

In Step S605, the response module 353 obtains information of the MSS from the received SYN+ACK packet, and stores the obtained information of the MSS in the MSS (T16).

In Step S606, the response module 353 transmits the received packet via the user side interface 341 to the user terminal 1, and ends the processing.

Next, a flow of communication in the communication system is described referring to a sequential diagram. In the sequential diagram, the router 2-1 for coupling the user terminal 1 and the relay apparatus 3 performs only packet transfer between the user terminal 1 and the relay apparatus 3, and thus description thereof is omitted.

### Operation Example 1

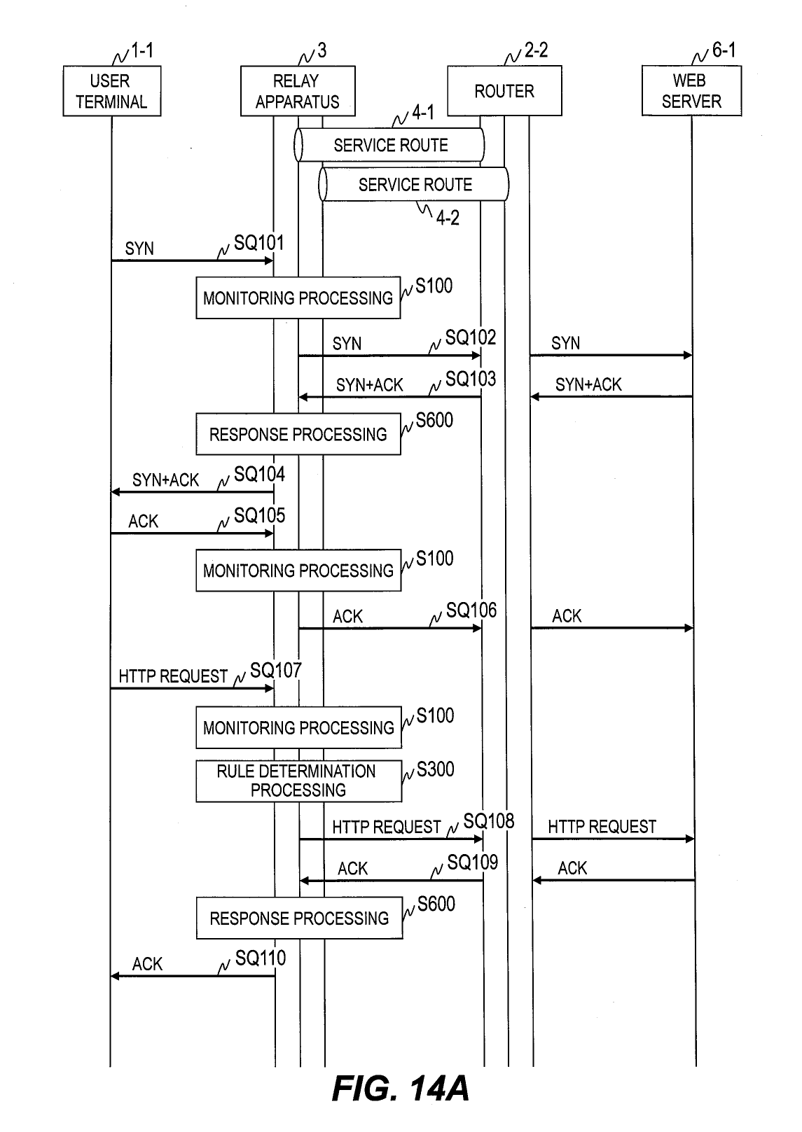

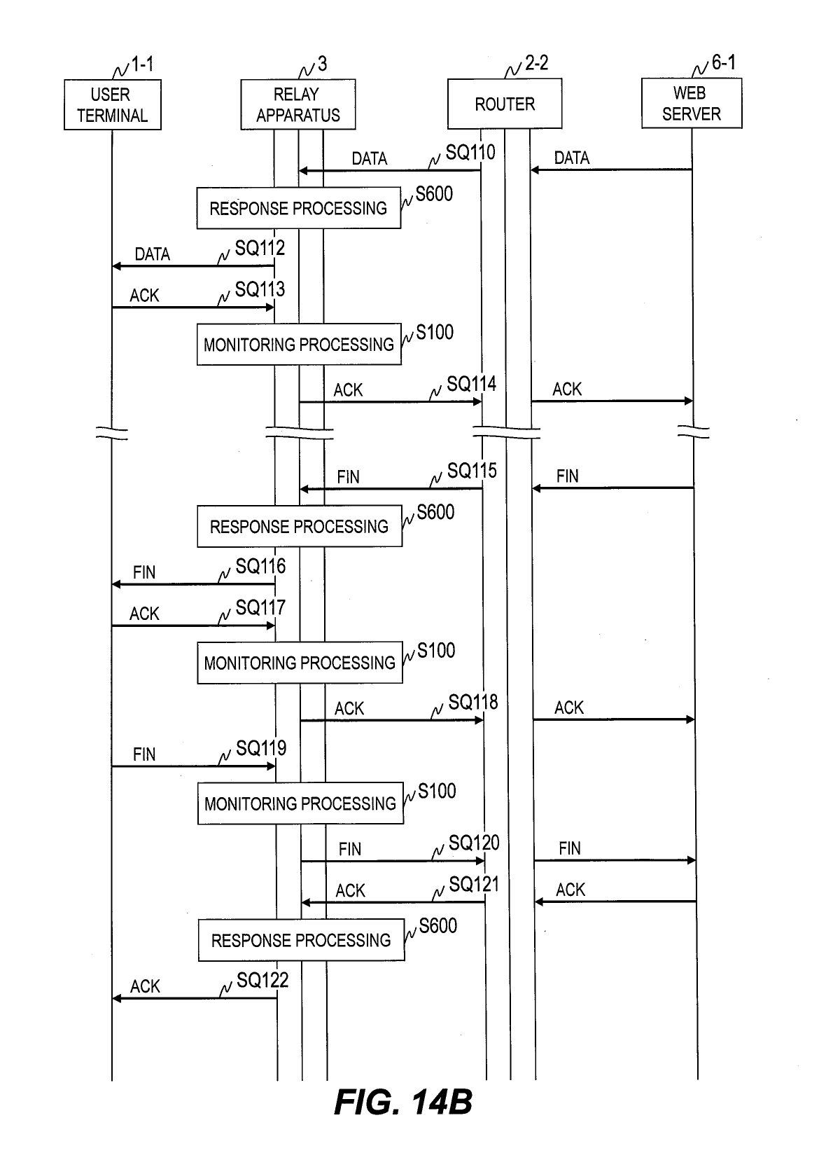

FIGS. 14A and 14B are sequential diagrams each illustrating a flow of communication when the service route 4 in the communication system according to the embodiment of this invention is not switched.

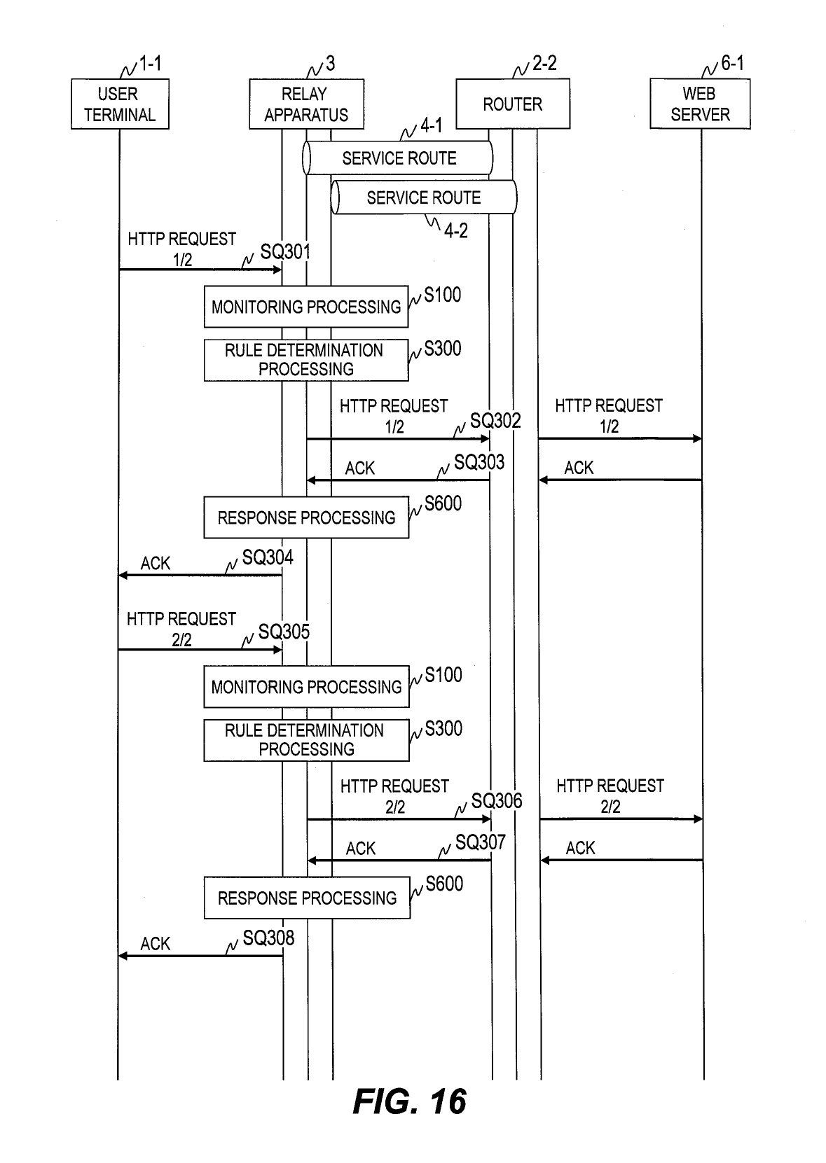

In Operation Example 1, the user terminal 1-1 having an IP address “10.0.0.1” requests contents (HTTP://server2.com/index.html) held in the web server 6-1 having an IP address “10.0.1.1”. In Operation Example 1, an HTTP request does not correspond to any one of the rules in the rule table (T2), and thus communication is carried out by using the service route 4-1. In Operation Example 1, it is supposed that the HTTP request is stored in one packet. An operation in a case where the HTTP request is divided into a plurality of packets to be transmitted is described below in Operation Example 3 illustrated in FIG. 16.

In SQ101, the user terminal 1-1 transmits a SYN packet addressed to the web server 6-1. The relay apparatus 3 starts the monitoring processing S100 in a case where the relay apparatus 3 receives the SYN packet.

In the monitoring processing S100, in Step S108, the monitoring module 352 determines whether or not the received SYN packet is a packet transmitted via HTTP. In this case, the SYN packet is determined to be a packet transmitted via HTTP (YES in Step S108). Accordingly, in Step S109, the monitoring module 352 registers connection information in the connection management table (T1). In Step S101 and SQ102, the monitoring module 352 transmits the received SYN packet to the web server 6-1 via the service 1 side interface 342.

In SQ103, in a case where the relay apparatus 3 receives a SYN+ACK packet addressed to the user terminal 1-1 from the web server 6-1, the relay apparatus 3 starts the response processing S600.

In the response processing S600, in Step S603, the response module 353 determines whether or not the connection state (T17) is “SYN 1”. In this case, the connection state (T17) is determined to be “SYN 1” (YES in Step S603). Thus, in Step S604, the response module 353 updates the connection state (T17) to “SYN 2”. In Step S605, the response module 353 registers MSS information obtained from the received SYN+ACK packet in the MSS (T16). In Step S606 and SQ104, the response module 353 transmits the received SYN+ACK packet to the user terminal 1-1 via the user side interface 341.

In SQ105, in a case where the relay apparatus 3 receives an ACK packet addressed to the web server 6-1 from the user terminal 1-1, the relay apparatus 3 starts the monitoring processing S100.

In the monitoring processing S100, in Step S103, the monitoring module 352 determines whether or not the connection state (T17) of connection information present in the connection management table (T1) is “PROXY RESPONDING”. In this case, the connection state (T17) is not “PROXY RESPONDING” (NO in Step S103). Thus, in Step S105, the monitoring module 352 determines whether or not the received packet is an ACK packet and the connection state (T17) is “SYN 2”. In this case, the condition in Step S105 is satisfied (YES in Step S105). Thus, in Step S106, the monitoring module 352 updates the connection state (T17) to “ESTABLISHED”. In Step S110 and SQ106, the monitoring module 352 transmits the received ACK packet to the web server 6-1 via the service 1 side interface.

In SQ107, in a case where the relay apparatus 3 receives an HTTP request packet addressed to the web server 6-1 from the user terminal 1-1, the relay apparatus 3 starts the monitoring processing S100.

In the monitoring processing S100, the monitoring module 352 determines whether or not the condition of Step S105 is satisfied. In this case, the condition of Step S105 is not satisfied (NO in Step S105). Thus, in Step S107, the monitoring module 352 instructs the rule determination module 354 to carry out processing.

In the rule determination processing S300, in Step S302, the rule determination module 354 determines, because one packet includes an entire HTTP request, whether or not the connection state (T17) is “PART OF HTTP REQUEST HAS BEEN RECEIVED”. In this case, the connection state (T17) is not “PART OF HTTP REQUEST HAS BEEN RECEIVED” (NO in Step S302). Thus, in Step S304, the rule determination module 354 determines whether or not a rule corresponding to the HTTP request is present. In this case, it is determined that no corresponding rule is present (NO in Step S304). Accordingly, in Step S307, the rule determination module 354 deletes the connection information from the connection management table (T1). In Step S311 and SQ108, the rule determination module 354 transmits the received HTTP request packet to the web server 6-1 via the service 1 side interface 342.

In SQ109, in a case where the relay apparatus 3 receives an ACK packet addressed to the user terminal 1-1 from the web server 6-1, the relay apparatus 3 starts the response processing S600.

In the response processing S600, in Step S601, the response module 353 determines whether or not the received packet is a SYN+ACK packet. In this case, the received packet is not a SYN+ACK packet (NO in Step S601). Thus, in Step S606 and SQ110, the response module 353 transmits the received ACK packet to the user terminal 1-1 via the user side interface 341.

In a case where the relay apparatus 3 receives a packet storing a content addressed to the user terminal 1-1 from the web server 6-1 in SQ111, the relay apparatus 3 starts the response processing S600. In the response processing S600, in Step S606 and SQ112, as in the case of SQ110, the received packet is transmitted to the user terminal 1-1 via the user side interface 341.

In SQ113, in a case where the relay apparatus 3 receives an ACK packet addressed to the web server 6-1 from the user terminal 1-1, the relay apparatus 3 starts the monitoring processing S100.

In the monitoring processing S100, in Step S102, the monitoring module 352 determines whether or not any connection information is present in the connection management table (T1). In this case, the connection information has been deleted in Step S307 in the rule determination processing S300 executed after SQ107. Thus, in Step S110 and SQ114, the monitoring module 352 transmits the received ACK packet to the web server 6-1 via the service 1 side interface 342.

The relay apparatus 3 repeatedly carries out the processing of from SQ103 to SQ114 until all the contents are transmitted.

The relay apparatus 3 starts the response processing S600 after the relay apparatus 3 receives a FIN packet addressed to the user terminal 1-1 from the web server 6-1 in SQ115 or receives an ACK packet addressed to the user terminal 1-1 in SQ121. A flow of the response processing S600 is similar to that of the response processing S600 executed after SQ109. In other words, in SQ116 and SQ122, the received FIN packet or the received ACK packet is transmitted to the user terminal 1-1 via the user side interface 341.

The relay apparatus 3 starts the monitoring processing S100 after the relay apparatus 3 receives an ACK packet addressed to the web server 6-1 from the user terminal 1-1 in SQ117 or receives a FIN packet in SQ119. A flow of the monitoring processing S100 is similar to that of the monitoring processing S100 executed after SQ113. In other words, in SQ118 and SQ120, the received ACK packet or the received FIN packet is transmitted to web server 6-1 via the service 1 side interface 342.

### Operation Example 2

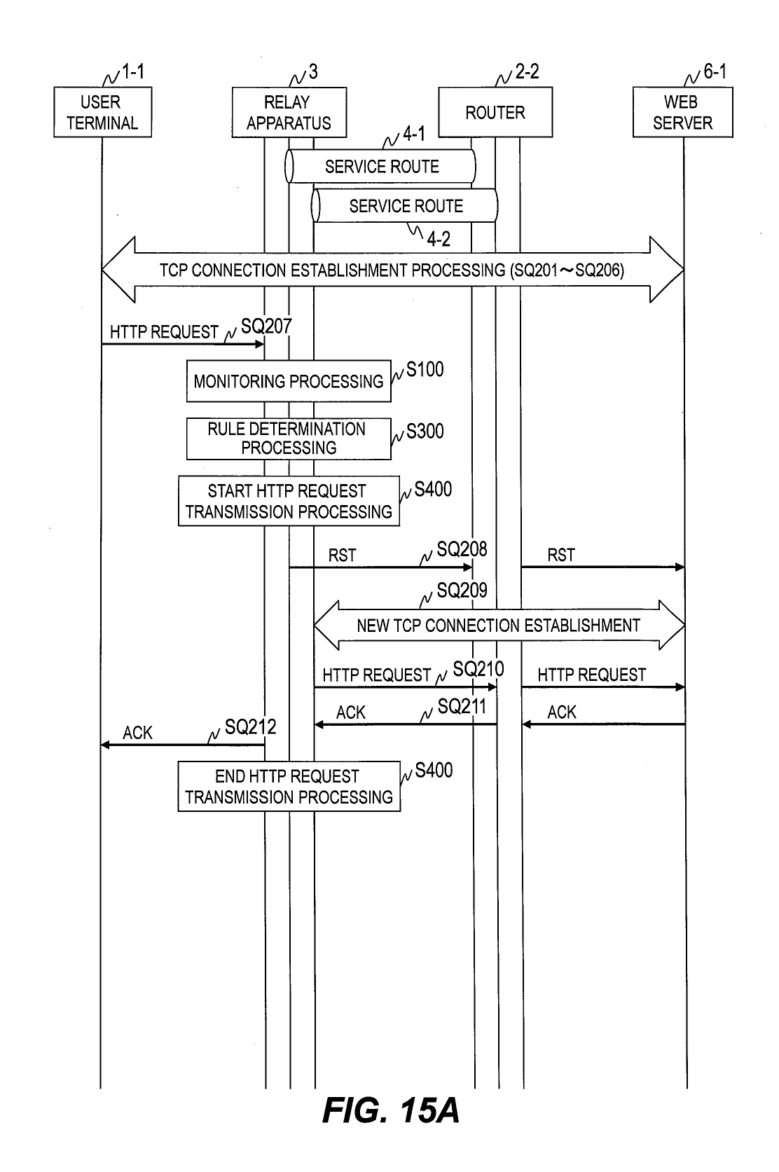

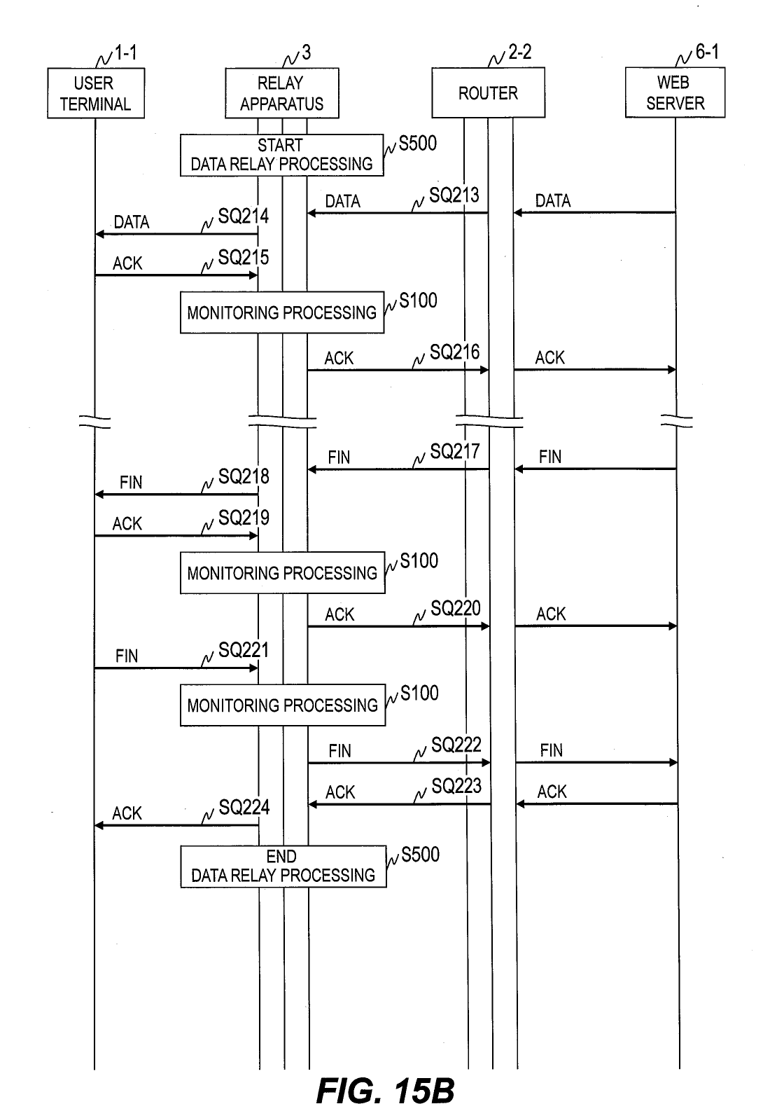

FIGS. 15A and 15B are sequential diagrams each illustrating a flow of communication when the service route 4 in the communication system according to the embodiment of this invention is switched.

In Operation Example 2, the user terminal 1-1 having an IP address “10.0.0.3” requests contents (HTTP://server3.com/IMAGE.JPG) held in the web server 6-1 having an IP address “10.0.1.3”. In Operation Example 2, an HTTP request corresponds to any one of the rules in the rule table (T2), and thus communication is carried out by using the service route 4-2.

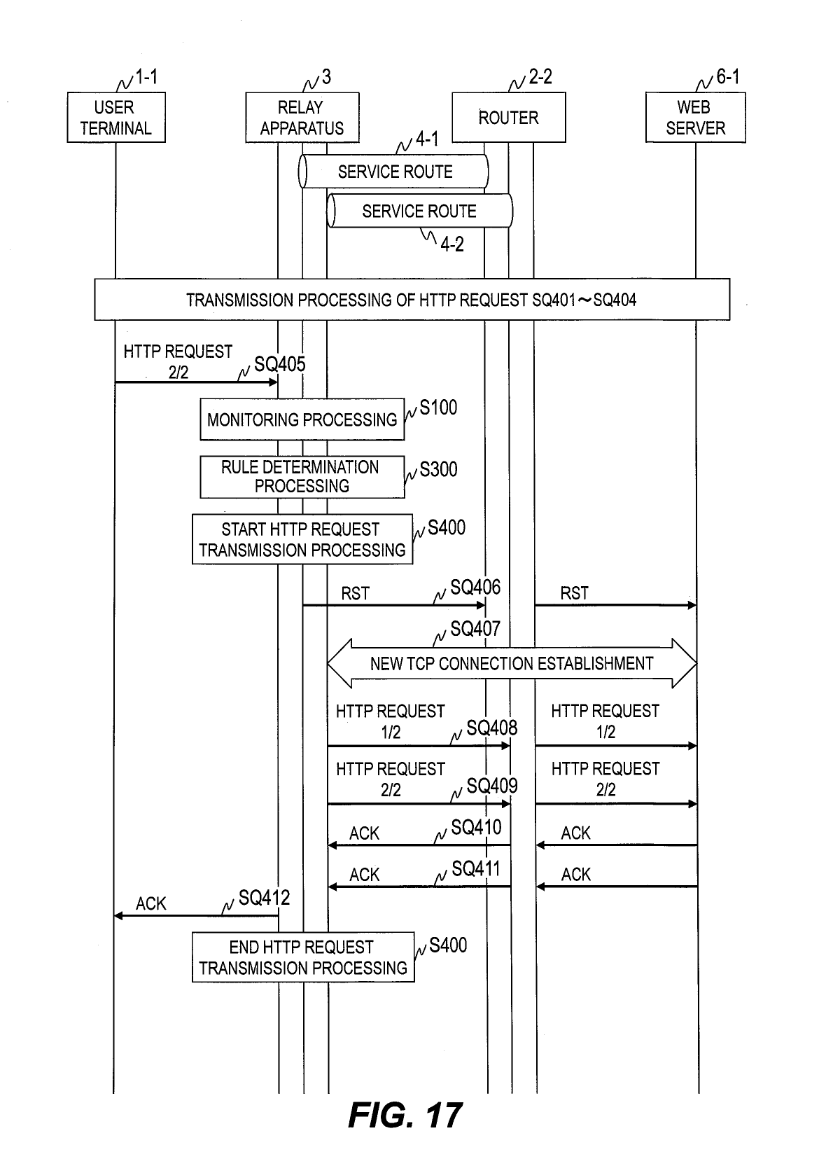

In Operation Example 2, it is supposed that the HTTP request is stored in one packet. An operation in a case where the HTTP request is divided into a plurality of packets to be transmitted is described below in Operation Example 4 illustrated in FIG. 17.

Processing of TCP connection establishment from SQ201 to SQ206 is similar to that from SQ101 to SQ106, and thus description thereof is omitted.

In SQ207, in a case where the relay apparatus 3 receives an HTTP request packet addressed to the web server 6-1 from the user terminal 1-1, the relay apparatus 3 starts the monitoring processing S100.

In the monitoring processing S100, the condition of Step S105 is not satisfied (NO in Step S105), and thus, in Step S107, the monitoring module 352 instructs the rule determination module 354 to carry out processing.

In the rule determination processing S300, because of the determination by the rule determination module 354 that a rule corresponding to the HTTP request is present, in Step S305, the rule determination module 354 updates the connection state (T13) to “PROXY RESPONDING”. In Step S306, the rule determination module 354 instructs the HTTP request transmission module 355 to carry out processing.

In the HTTP request transmission processing S400, in Step S401, the HTTP request transmission module 355 registers proxy response information in the proxy response table (T3). In Step S402 and SQ208, the HTTP request transmission module 355 transmits an RST packet to the web server 6-1 via the service route 4-1. In Step S403 and SQ209, the HTTP request transmission module 355 establishes new TCP connection on the service route 4-2, and updates the proxy response information based on information of the new TCP connection. In Step S404 and SQ210, the HTTP request transmission module 355 rewrites a header of the HTTP request packet received from the user terminal 1-1, and transmits the rewritten HTTP request packet to the web server 6-1 via the service 2 side interface.

In a case where the HTTP request transmission module 355 receives an ACK packet addressed to the relay apparatus 3 from the web server 6-1 in SQ211, in Step S405 and SQ212, the HTTP request transmission module 355 rewrites a header of the ACK packet based on the proxy response information, and transmits the rewritten ACK packet to the user terminal 1-1 via the user side interface 341. Then, in Step S406, the HTTP request transmission module 355 instructs the data relay module 356 to carry out processing.

An ACK number and a sequence number used when the TCP connection is established between the user terminal 1-1 and the web server 6-1 are continuously used as an ACK number and a sequence number of the ACK packet to be transmitted to the user terminal 1-1. Accordingly, the user terminal 1-1 recognizes communication as if the communication is carried out via the original TCP connection. In other words, the user terminal 1-1 does not recognize switching of a communication route or the like.

In the data relay processing 5500, in Step S503 and SQ214, in a case where the data relay module 356 receives a packet including a content addressed to the relay apparatus 3 from the web server 6-1 in SQ213, the data relay module 356 rewrites a header of the packet storing the content based on the user terminal side information (T33) of the proxy response information, and transmits the rewritten packet to the user terminal 1-1 via the user side interface 341.

As in the case of SQ212, an ACK number and a sequence number used when the TCP connection is established between the user terminal 1-1 and the web server 6-1 are continuously used as an ACK number and a sequence number of the packet including the content to be transmitted to the user terminal 1-1.

In SQ215, in a case where the relay apparatus 3 receives an ACK packet addressed to the web server 6-1 from the user terminal 1-1, the relay apparatus 3 starts the monitoring processing S100.

In the monitoring processing S100, because the connection state (T17) is “PROXY RESPONDING”, the monitoring module 352 starts the user side proxy response processing S200. In the user side proxy response processing S200, because the received packet is an ACK packet, in Step S202, the monitoring module 352 outputs an ACK reception notification to the data relay module 356.

At this time, in the data relay processing S500, in Step S504 and SQ216, the data relay module 356 rewrites a header of the ACK packet based on the web server side information (T34) of the proxy response information, and transmits the rewritten ACK packet to the web server 6-1 via the service 2 side interface 343.

An ACK number and a sequence number used when the new TCP connection is established between the relay apparatus 3 and the web server 6-1 are continuously used as an ACK number and a sequence number of the ACK packet to be transmitted to the web server 6-1.

The processing of from SQ213 to SQ216 is repeatedly executed until all the contents are transmitted.

In Step S505 and SQ218, in a case where the relay apparatus 3 receives a FIN packet addressed to the relay apparatus 3 from the web server 6-1 in SQ217, the data relay module 356 rewrites a header of the FIN packet based on the user terminal side information (T33) of the proxy response information, and transmits the rewritten FIN packet to the user terminal 1-1 via the user side interface 341.

As in the case of SQ212, an ACK number and a sequence number used when the TCP connection is established between the user terminal 1-1 and the web server 6-1 are continuously used as an ACK number and a sequence number of the packet including a content to be transmitted to the user terminal 1-1.

In SQ219, in a case where the relay apparatus 3 receives an ACK packet addressed to the web server 6-1 from the user terminal 1-1, the relay apparatus 3 starts the monitoring processing S100.

A flow of the monitoring processing S100 is similar to that of the monitoring processing S100 executed after SQ215. In other words, in Step S202, an ACK reception notification is output to the data relay module 356.

At this time, in the data relay processing 5500, in Step S506 and SQ220, the data relay module 356 rewrites a header of the ACK packet based on the web server side information (T34) of the proxy response information, and transmits the rewritten ACK packet to the web server 6-1 via the service 2 side interface 343.

An ACK number and a sequence number used when the new TCP connection is established between the relay apparatus 3 and the web server 6-1 are continuously used as an ACK number and a sequence number of the ACK packet to be transmitted to the web server 6-1.

In SQ221, in a case where the relay apparatus 3 receives a FIN packet addressed to the web server 6-1 from the user terminal 1-1, the relay apparatus 3 starts the monitoring processing S100.

In the monitoring processing S100, because the connection state (T17) is “PROXY RESPONDING”, the monitoring module 352 starts the user side proxy response processing S200. In the user side proxy response processing S200, in Step S203, the monitoring module 352 determines whether or not the received packet is a FIN packet. In this case, the received packet is a FIN packet (YES in Step S203). Thus, in Step S204, the monitoring module 352 outputs a FIN reception notification to the data relay module 356.

At this time, in the data relay processing 5500, in Step S507 and SQ222, the data relay module 356 rewrites a header of the FIN packet based on the web server side information (T34) of the proxy response information, and transmits the rewritten FIN packet to the web server 6-1 via the service 2 side interface 343.

An ACK number and a sequence number used when the new TCP connection is established between the relay apparatus 3 and the web server 6-1 are continuously used as an ACK number and a sequence number of the FIN packet to be transmitted to the web server 6-1.

In a case where the relay apparatus 3 receives an ACK packet addressed to the relay apparatus 3 from the web server 6-1 in SQ223, in Step S508 and SQ224, the data relay module 356 rewrites a header of the ACK packet based on the user terminal side information (T33) of the proxy response information, and transmits the rewritten ACK packet to the user terminal 1-1 via the user side interface 341. Then, in Step S509, the data relay module 356 deletes the connection information from the connection management table (T1), and deletes the proxy response information from the proxy response table (T3).

As in the case of SQ212, an ACK number and a sequence number used when the TCP connection is established between the user terminal 1-1 and the web server 6-1 are continuously used as an ACK number and a sequence number of the packet including a content to be transmitted to the user terminal 1-1.

In Operation Example 2, the user terminal 1-1 is only required to transmit a packet to the web server 6-1 by using the information (ACK number and sequence number) of the TCP connection established between the user terminal 1-1 and the web server 6-1. Thus, the user terminal 1-1 is not required to be aware of switching of the service route 4. When the service route 4 is switched, the TCP connection between the user terminal 1-1 and the relay apparatus 3 is maintained. Thus, the user terminal 1-1 does not recognize disconnection of the TCP connection when the service route 4 is switched. In other words, the relay apparatus 3 can switch the service route 4 without any particular changes for the user terminal 1-1.

### Operation Example 3

FIG. 16 is a sequential diagram illustrating a flow of communication when the service route 4 in the communication system according to the embodiment of this invention is not switched.

Operation Example 3 is substantially similar to Operation Example 1, but different in that an HTTP request is divided into a plurality of packets to be transmitted. Now, Operation Example 3 is described mainly focusing on the difference from Operation Example 1.

Processing until TCP connection establishment is similar to that of Operation Example 1, and thus description thereof is omitted.

In a case where the relay apparatus 3 receives an HTTP request 1/2 addressed to the web server 6-1 from the user terminal 1-1 in SQ301, the relay apparatus 3 starts the monitoring processing S100. In the monitoring processing S100, the condition of Step S105 is not satisfied (NO in Step S105), and thus the monitoring module 352 instructs the rule determination module 354 to carry out processing.

In the rule determination processing S300, in Step S301, the rule determination module determines whether or not an entire HTTP request has been received. In this case, the entire HTTP request has not been received (NO in Step S301). Therefore, in Step S308, the rule determination module 354 copies the received HTTP request packet in the packet storage unit 33, and in Step S309, the rule determination module 354 sets a pointer indicating a storage position of the packet as the packet pointer (T18) of connection information. Further, in Step S310, the rule determination module 354 updates the connection state (T17) to “PART OF HTTP REQUEST HAS BEEN RECEIVED”. Then, in Step S311 and SQ302, the rule determination module 354 transmits the received HTTP request packet to the web server 6-1 via the service 1 side interface 342.

In SQ303, in a case where the relay apparatus 3 receives an ACK packet addressed to the user terminal 1-1 from the web server 6-1, the relay apparatus 3 starts the response processing S600.

A flow of the response processing S600 is similar to that of the response processing S600 executed after SQ109. In other words, in Step S606 and SQ304, the response module 353 transmits the received ACK packet to the user terminal 1-1 via the user side interface 341.

In SQ305, in a case where the relay apparatus 3 receives an HTTP request 2/2 addressed to the web server 6-1 from the user terminal 1-1, the relay apparatus 3 starts the monitoring processing S100.

In the monitoring processing S100, the condition of Step S105 is not satisfied (NO in Step S105), and thus, the monitoring module 352 instructs the rule determination module 354 to carry out processing.

In the rule determination processing S300, because it is determined that the entire HTTP request has been received (YES in Step S301), in Step S302, the rule determination module 354 determines whether or not the connection state (T17) is “PART OF HTTP REQUEST HAS BEEN RECEIVED”.

In this case, the connection state (T17) is “PART OF HTTP REQUEST HAS BEEN RECEIVED” (YES in Step S302). Thus, in Step S303, the rule determination module 354 reads an HTTP request packet from the packet storage unit 33 based on the packet pointer (T18). In Step S304, the rule determination module 354 determines whether or not the HTTP request corresponds to any one of the rules in the rule table (T2). In this case, no corresponding rule is present (NO in Step S304). Thus, in Step S307, the rule determination module 354 deletes the connection information from the connection management table (T1). In Step S311 and SQ306, the rule determination module 354 transmits the received HTTP request packet 2/2 to the web server 6-1 via the service 1 side interface 342.

In SQ307, in a case where the relay apparatus 3 receives an ACK packet addressed to the user terminal 1-1 from the web server 6-1, the relay apparatus 3 starts the response processing S600.

A flow of the response processing S600 is similar to that of the response processing S600 executed after SQ109. In other words, in Step S606 and SQ308, the response module 353 transmits the received ACK packet to the user terminal 1-1 via the user side interface 341.

FIG. 16 illustrates the example in which the HTTP packet is divided into two packets. However, this invention is not limited to this example. The HTTP request may be divided into three or more packets. In such a case, the processing of from SQ301 to SQ304 is executed repeatedly until the entire HTTP request is received. In a case where the entire HTTP request is received, the processing of from SQ305 to SQ308 is executed.

### Operation Example 4

FIG. 17 is a sequential diagram illustrating a flow of communication when the service route 4 in the communication system according to the embodiment of this invention is switched.

Operation Example 4 is substantially similar to Operation Example 2, but different in that an HTTP request is divided into a plurality of packets to be transmitted. Now, Operation Example 4 is described mainly focusing on the difference from Operation Example 2.

Processing of from SQ401 to SQ404 is similar to that from SQ301 to SQ304, and thus description thereof is omitted.

In a case where the relay apparatus 3 receives an HTTP request packet 2/2 addressed to the web server 6-1 from the user terminal 1-1 in SQ405, the relay apparatus 3 starts the monitoring processing S100. A flow of the monitoring processing S100 is similar to that of the monitoring processing S100 executed after SQ305. In other words, the monitoring module 352 instructs the rule determination module 354 to carry out processing.

In the rule determination processing S300, because a rule corresponding to the HTTP request is present (YES in Step S304), in Step S305, the rule determination module 354 updates the connection state (T17) to “PROXY RESPONDING”. In Step S306, the rule determination module 354 instructs the HTTP request transmission module 355 to carry out processing.

In the HTTP request transmission processing S400, in Step S401, the HTTP request transmission module 355 registers proxy response information in the proxy response table (T3). In Step S402 and SQ406, the HTTP request transmission module 355 transmits an RST packet. In Step S403 and SQ407, the HTTP request transmission module 355 establishes new TCP connection, and updates the proxy response information. In Step S404, SQ408, and SQ409, the HTTP request transmission module 355 rewrites respective headers of the HTTP request packet 1/2 and the HTTP request packet 2/2 based on the web server side information (T34) of the proxy response information, and transmits the rewritten HTTP request packet 1/2 and the rewritten HTTP request packet 2/2 to the web server 6-1 via the service 2 side interface 343.

In a case where the relay apparatus 3 receives an ACK packet addressed to the relay apparatus 3 from the web server 6-1 in SQ410 and SQ411, in Step S405 and SQ412, the HTTP request transmission module 355 rewrites a header of the ACK packet based on the user terminal side information (T33) of the proxy response information, and transmits the rewritten ACK packet to the user terminal 1-1 via the user side interface 341.

FIG. 17 illustrates the example in which the HTTP packet is divided into two packets. However, this invention is not limited to this example. The HTTP request may be divided into three or more packets. In such a case, the processing of from SQ301 to SQ304 is executed repeatedly until the entire HTTP request is received. In a case where the entire HTTP request is received, the processing of from SQ405 to SQ408 is executed.

As described above, according to this invention, without significantly changing the existing network configuration such as the user terminal 1 or the web server 6, and without performing any special operation by the user terminal 1 or the web serve 6, the relay apparatus 3 can switch the service route 4 based on the analysis result of the HTTP request such as the type of the application or the data via HTTP. Further, the relay apparatus 3 can switch the service route 4 without the user terminal 1 being aware of route switching.

As a result, data can be distributed to offloading communication routes, and traffic offloading that does not affect the other user traffic can be achieved. Further, new charging methods can be employed for collecting fees in a different way depending on service networks to be used while switching service routes having different characteristics depending on the type of applications and data.

This embodiment has been described by way of example in which two service routes 4 are provided. However, the number of service routes 4 may be three or more. In this case, a new service route column may be associated with the rule of the rule table (T2). Accordingly, the relay apparatus 3 specifies, in a case where an HTTP request packet satisfying the HTTP request condition (T26) has been received, a service route 4 corresponding to the rule, and establishes new TCP connection to the service route 4.

This embodiment has been described by way of example of the communication using HTTP, but similar procedures can be employed for an application that uses a communication protocol in which TCP is a protocol for the higher layer, such as session initiation protocol (SIP).

This invention is not limited to the above-described embodiments but includes various modifications. The above-described embodiments are explained in details for better understanding of this invention and are not limited to those including all the configurations described above. A part of the configuration of one embodiment may be replaced with that of another embodiment; the configuration of one embodiment may be incorporated to the configuration of another embodiment. A part of the configuration of each embodiment may be added, deleted, or replaced by that of a different configuration.

The above-described configurations, functions, processing modules, and processing means, for all or a part of them, may be implemented by hardware: for example, by designing an integrated circuit.

The above-described configurations and functions may be implemented by software, which means that a processor interprets and executes programs providing the functions.

The information of programs, tables, and files to implement the functions may be stored in a storage device such as a memory, a hard disk drive, or an SSD (a Solid State Drive), or a storage medium such as an IC card, or an SD card.

The drawings shows control lines and information lines as considered necessary for explanation but do not show all control lines or information lines in the products. It can be considered that almost of all components are actually interconnected.

What is claimed is:

1. A relay apparatus for transferring data between a terminal on which an application for carrying out communication by using TCP runs and a server for transmitting data requested by the application,
the relay apparatus comprising:
a processor;
a memory coupled to the processor;
a plurality of network interfaces coupled to the processor and configured to couple to other apparatus,
the relay apparatus being configured to be coupled to the terminal via a first network, and be coupled to the server via a plurality of communication routes included in a second network,
the relay apparatus including,
a TCP management module for monitoring a packet to be transmitted and received by using TCP connection established between the terminal and the server via the first network and one of the plurality of communication routes included in the second network;
a determination module for analyzing a request packet in a case where the TCP management module detects reception of the request packet through which the application running on the terminal requests the server to transmit data, and for determining whether or not to switch a communication route of the second network for transmitting the request packet based on a result of the analysis;
a request transmission module for establishing new TCP connection to be used by the relay apparatus and the server to carry out communication on a new communication route in a case where the determination module determines to switch to a new communication route of the second network, and for transmitting the request packet to the server by using the new TCP connection; and
a data relay module for transferring a data storage packet including the data requested by the application to the terminal by using the new TCP connection.

2. The relay apparatus according to claim 1, wherein:
the relay apparatus holds conversion information in which terminal side information used for communication using the TCP connection and server side information used for communication using the new TCP connection are associated with each other;
the terminal side information includes an address of the terminal, a port number of the terminal, a sequence number used by the terminal for communication, and an ACK number used by the terminal for communication;
the server side information includes an address of the relay apparatus, a port number of the relay apparatus, a sequence number used by the relay apparatus for communication, and an ACK number used by the relay apparatus for communication;
the packet to be transmitted and received between the terminal and the server includes a transmission source address, a transmission source port number, a destination address, a destination port number, a sequence number, and an ACK number;
the request transmission module is configured to:
rewrite, based on the server side information of the conversion information, the transmission source address, the transmission source port number, the sequence number, and the ACK number which are included in the request packet; and
transmit the rewritten request packet to the server; and
the data relay module is configured to:
rewrite, based on the terminal side information of the conversion information, the destination address, the destination port number, the sequence number, and the ACK number which are included in the data storage packet in a case where the data storage packet is received from the server; and
transmit the rewritten data storage packet to the terminal.

3. The relay apparatus according to claim 2, wherein the request transmission module is configured to:
set, as the terminal side information, the address of the terminal, the port number of the terminal, the sequence number used by the terminal for communication, and the ACK number used by the terminal for communication, which are obtained from the request packet; and
set, as the server side information, the address of the relay apparatus, the port number of the relay apparatus, the sequence number used by the relay apparatus for communication, and the ACK number used by the relay apparatus for communication, which are determined in a case of establishing the new TCP connection.

4. The relay apparatus according to claim 2, wherein:
the relay apparatus holds rule information storing a plurality of rules, each of the plurality of rules includes conditions on a communication protocol used by the application for communication to the server; and
the determination module is configured to:
refer to the rule information based on the result of the analysis to determine whether or not a rule corresponding to the request packet is present; and
determine to switch the communication route for transmitting the request packet in a case where it is determined that the rule corresponding to the request packet is present.

5. The relay apparatus according to claim 2, wherein the request transmission module transmits an initialization packet for disconnecting the TCP connection on a currently used communication route to the server by using the TCP connection on the communication route in a case where it is determined to switch the communication route for transmitting the request packet.

6. A data transfer method for a relay apparatus for transferring data between a terminal on which an application for carrying out communication by using TCP runs and a server for transmitting data requested by the application,
the relay apparatus including:
a processor;
a memory coupled to the processor;
a plurality of network interfaces coupled to the processor and configured to couple to other apparatus,
the relay apparatus being configured to be coupled to the terminal via a first network, and be coupled to the server via a plurality of communication routes included in a second network;
the data transfer method including:
a first step of monitoring, by the relay apparatus, a packet to be transmitted and received by using TCP connection established between the terminal and the server via the first network and one of the plurality of communication routes included in the second network;
a second step of analyzing, by the relay apparatus, a request packet in a case where reception of the request packet through which the application running on the terminal requests the server to transmit data is detected, and determining whether or not to switch a communication route of the second network for transmitting the request packet based on a result of the analysis;
a third step of establishing, by the relay apparatus, new TCP connection to be used by the relay apparatus and the server to carry out communication on a new communication route in a case where it is determined to switch to a new communication route of the second network, and transmitting the request packet to the server by using the new TCP connection; and
a fourth step of transferring, by the relay apparatus, a data storage packet including the data requested by the application to the terminal by using the new TCP connection.

7. The data transfer method according to claim 6, wherein:
the relay apparatus holds conversion information in which terminal side information used for communication using the TCP connection and server side information used for communication using the new TCP connection are associated with each other;
the terminal side information includes an address of the terminal, a port number of the terminal, a sequence number used by the terminal for communication, and an ACK number used by the terminal for communication;
the server side information includes an address of the relay apparatus, a port number of the relay apparatus, a sequence number used by the relay apparatus for communication, and an ACK number used by the relay apparatus for communication;
the packet to be transmitted and received between the terminal and the server includes a transmission source address, a transmission source port number, a destination address, a destination port number, a sequence number, and an ACK number;
the third step includes the steps of:
rewriting, based on the server side information of the conversion information, the transmission source address, the transmission source port number, the sequence number, and the ACK number which are included in the request packet; and
transmitting the rewritten request packet to the server; and
the fourth step includes the steps of:
rewriting, based on the terminal side information of the conversion information, the destination address, the destination port number, the sequence number, and the ACK number which are included in the data storage packet in a case where the data storage packet is received from the server; and
transmitting the rewritten data storage packet to the terminal.

8. The data transfer method according to claim 7, wherein the third step includes the steps of:
setting, as the terminal side information, the address of the terminal, the port number of the terminal, the sequence number used by the terminal for communication, and the ACK number used by the terminal for communication, which are obtained from the request packet; and
setting, as the server side information, the address of the relay apparatus, the port number of the relay apparatus, the sequence number used by the relay apparatus for communication, and the ACK number used by the relay apparatus for communication, which are determined in a case of establishing the new TCP connection.

9. The data transfer method according to claim 7, wherein:
the relay apparatus holds rule information storing a plurality of rules, each of the plurality of rules includes conditions on a communication protocol used by the application for communication to the server; and
the second step includes the steps of:
referring to the rule information based on the result of the analysis to determine whether or not a rule corresponding to the request packet is present; and
determining to switch the communication route for transmitting the request packet in a case where it is determined that the rule corresponding to the request packet is present.

10. The data transfer method according to claim 7, wherein the third step includes the step of transmitting an initialization packet for disconnecting the TCP connection on a currently used communication route to the server by using the TCP connection on the communication route in a case where it is determined to switch the communication route for transmitting the request packet.
